(19) United States
(12) Patent Application Publication
(10) Pub. No.: US 2026/0316493 A1
(43) Pub. Date: Oct. 15, 2026

(54) TIRE

(71) Applicant: The Yokohama Rubber Co., LTD., Kanagawa (JP)

(72) Inventor: Takafumi GOHARA, Kanagawa (JP)

(21) Appl. No.: 19/462,374

(22) Filed: Jan. 28, 2026

(30) Foreign Application Priority Data
Feb. 6, 2025 (JP) 2025-018624

(51) Int. Cl. B60C 11/03; B60C 11/12

(52) U.S. Cl. CPC B60C 11/0309; B60C 11/1204; B60C 11/1236; B60C 2011/0346; B60C 2011/0348; B60C 2011/0355; B60C 2011/0365; B60C 2011/0367; B60C 2011/1213; B60C 2011/1254; B60C 2200/06

(57) ABSTRACT

A land portion row defined by circumferential grooves has a center, middle and shoulder land portion rows. The circumferential groove separating the center land portion row from the middle land portion row is a narrow groove having a groove width in a range 1.5 mm≤W1≤5.0 mm. In each of the center and middle land portion rows, a lug groove is provided with both ends opening to the circumferential grooves. The groove width W1 and the groove depth D1 of the narrow groove satisfy 4≤D1/W1≤14. A groove width Wc of a center lug groove and the groove width W1 of the narrow groove satisfy W1≤Wc. A groove width Wm of a middle lug groove and the groove width W1 of the narrow groove satisfy W1≤Wm. An inclination angle θs of the shoulder lug groove and an inclination angle θm of the middle lug groove satisfy θs<θm.

### CROSS-REFERENCE TO RELATED APPLICATIONS

This application claims priority pursuant to 35 U.S.C. 119(a) to Japanese Patent Application No. 2025-018624, filed Feb. 6, 2025, which application is incorporated herein by reference in its entirety.

### FIELD OF THE INVENTION

The present technology relates to a tire.

### BACKGROUND OF THE INVENTION

A tire mounted on a vehicle includes a groove formed in a tread portion for the purpose of ensuring various types of performance in accordance with the use mode of the tire, the shape of the groove being devised in an attempt to improve the performance. For example, a heavy duty tire described in Japan Patent No. 5870082 has provided thereon a pair of center main grooves extending in a tire circumferential direction and a pair of shoulder main grooves disposed at an outer side in a tire axial direction of the center main grooves and extending in a tire circumferential direction, groove widths of the shoulder main grooves being larger than groove widths of the center main grooves, a middle land portion having provided thereon a plurality of middle lateral grooves inclined with respect to the tire axial direction, a shoulder land portion having provided thereon a plurality of shoulder lateral grooves inclined with respect to the tire axial direction, and an angle θs of the shoulder lateral grooves with respect to the tire axial direction being larger than an angle θm of the middle lateral grooves with respect to the tire axial direction.

A pneumatic tire described in Japan Patent No. 4283783 has a center region, a shoulder region, and a middle region by provision of longitudinal grooves continuously extending in the tire circumferential direction on both sides of the tire equator, in the center region, center blocks aligned in the tire circumferential direction are formed, the shoulder region or the middle region has a plurality of blocks defined by provision of a plurality of lateral grooves extending in the width direction and auxiliary longitudinal grooves connecting the lateral grooves adjacent to each other in the tire circumferential direction, the lateral groove including a first lateral groove having one cross-shaped groove intersection portion, and a second lateral groove having two T-shaped groove intersection portions, the first lateral grooves and the second lateral grooves being alternately provided in the tire circumferential direction, the groove width of the lateral groove being larger than the groove width of the auxiliary longitudinal groove, and the tread portion having a land ratio of 67 to 75%.

Here, for a winter tire that is a tire devised to ensure running performance in winter, a block base exhibiting a high groove area ratio and flexible movement tends to be employed in order to ensure on-snow performance when running on a snow-covered road surface. Therefore, the rolling resistance of winter tires tends to deteriorate. As a method for improving the rolling resistance, there has been increasingly employed a tread pattern that can reduce the rolling resistance by forming circumferential grooves as narrow grooves and shifting block rows toward a center portion so as to reduce deformation of blocks. However, forming the circumferential grooves as narrow grooves suppresses deformation of blocks so that it may become difficult to effectively obtain snow column shear force during travel on snow-covered road surfaces, making traction performance liable to decrease during travel on snow-covered road surfaces. Therefore, it has been very difficult to reduce the rolling resistance while suppressing decrease of on-snow performance.

### SUMMARY OF THE INVENTION

The present technology provides a tire that can provide a reduced rolling resistance while suppressing decrease of on-snow performance.

A tire according to an embodiment of the present technology includes at least four circumferential grooves disposed in a tread portion and extending in a tire circumferential direction, and a plurality of land portion rows defined by the circumferential grooves. The land portion rows include a center land portion row that is a land portion row of the land portion rows disposed at a position closest to a tire equatorial plane, a middle land portion row that is the land portion row adjacent to the center land portion row with a circumferential groove of the circumferential grooves interposed, and a shoulder land portion row that is the land portion row located outermost in the tire width direction among the plurality of land portion rows and adjacent to the middle land portion row with the circumferential groove interposed. The circumferential groove separating the center land portion row from the middle land portion row is a circumferential narrow groove having a groove width W1 in a range 1.5 mm≤W1≤5.0 mm. In each of the center land portion row and the middle land portion row, a lug groove both ends of which open to the circumferential groove is disposed, thereby the center land portion row has a center block, both sides of which in the tire circumferential direction are defined by the lug groove, and the middle land portion row has a middle block, both sides of which in the tire circumferential direction are defined by the lug groove. In each of the center block and the middle block, an open sipe both ends of which open to the circumferential grooves is disposed. A groove width W2 of a shoulder circumferential groove that is the circumferential groove separating the middle land portion row from the shoulder land portion row and the groove width W1 of the circumferential narrow groove satisfy a relationship W1<W2. A groove depth D1 of the circumferential narrow groove and the groove width W1 satisfy a relationship 4≤D1/W1≤14. A groove width Wc of a center lug groove that is the lug groove defining the center block and the groove width W1 of the circumferential narrow groove satisfy a relationship W1≤Wc. A groove width Wm of a middle lug groove that is the lug groove defining the middle block and the groove width W1 of the circumferential narrow groove satisfy a relationship W1≤Wm. A shoulder lug groove that is a lug groove opening to the shoulder circumferential groove is disposed in the shoulder land portion row, and an inclination angle θs in the tire circumferential direction with respect to the tire width direction of the shoulder lug groove and an inclination angle θm in the tire circumferential direction with respect to the tire width direction of the middle lug groove satisfy a relationship θs<θm.

The tire according to an embodiment of the present technology exhibits an effect that can reduce the rolling resistance while suppressing decrease of on-snow performance.

### BRIEF DESCRIPTION OF DRAWINGS

FIG. 1 is a tire meridian cross-sectional view illustrating a main portion of a pneumatic tire according to an embodiment;

FIG. 2 is a plan view of a tread portion illustrated in FIG. 1;

FIG. 3 is a detailed view of a tread portion spanning from a center land portion row to shoulder land portion rows on one side;

FIG. 4 is an explanatory diagram of each lug groove illustrated in FIG. 3;

FIG. 5 is a cross-sectional view taken along a line A-A in FIG. 4;

FIG. 6 is a cross-sectional view taken along a line B-B in FIG. 4;

FIG. 7 is a cross-sectional view taken along a line C-C in FIG. 4;

FIG. 8 is an explanatory view of a center lug groove and a middle lug groove illustrated in FIG. 3;

FIG. 9 is an explanatory diagram illustrating a modified example of a pneumatic tire according to an embodiment, in which lug grooves are formed into a shape other than a crank shape, without any shoulder narrow grooves; and,

FIGS. 10A through 10H are tables listing results of a performance evaluation test of a pneumatic tire.

### DETAILED DESCRIPTION OF THE INVENTION

An embodiment according to the present technology will be described in detail below with reference to the drawings. However, the technology is not limited to the embodiment. Constituents of the embodiment include elements that are substitutable while maintaining consistency with the technology and obviously substitutable elements. The plurality of modified examples described in the embodiment can be combined as desired within the scope apparent to one skilled in the art.

### Embodiments

In the following description, the tire according to an embodiment of the present technology will be explained, taking a pneumatic tire 1 as an example. The pneumatic tire 1 that is an exemplary tire can be inflated with inert gas such as air, nitrogen, and the like. In the following description, “tire radial direction” refers to a direction orthogonal to a tire rotation axis (not illustrated) that is a rotation axis of the pneumatic tire 1 of an embodiment, “inner side in the tire radial direction” refers to a side toward the tire rotation axis in the tire radial direction, and “outer side in the tire radial direction” refers to a side away from the tire rotation axis in the tire radial direction. The term “tire circumferential direction” refers to a circumferential direction with the tire rotation axis as a center axis. The term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane orthogonal to the tire rotation axis and passing through the center of the tire width of the pneumatic tire 1. The tire equatorial plane CL aligns, in a position in the tire width direction, with a center line in the tire width direction corresponding to a center position of the pneumatic tire 1 in the tire width direction. The term “tire equator line” refers to a line lying on the tire equatorial plane CL along the tire circumferential direction of the pneumatic tire 1. The term “cross-section in the tire meridian direction (meridian cross-sectional view)” refers to a cross section of the tire taken along a plane including the tire rotation axis.

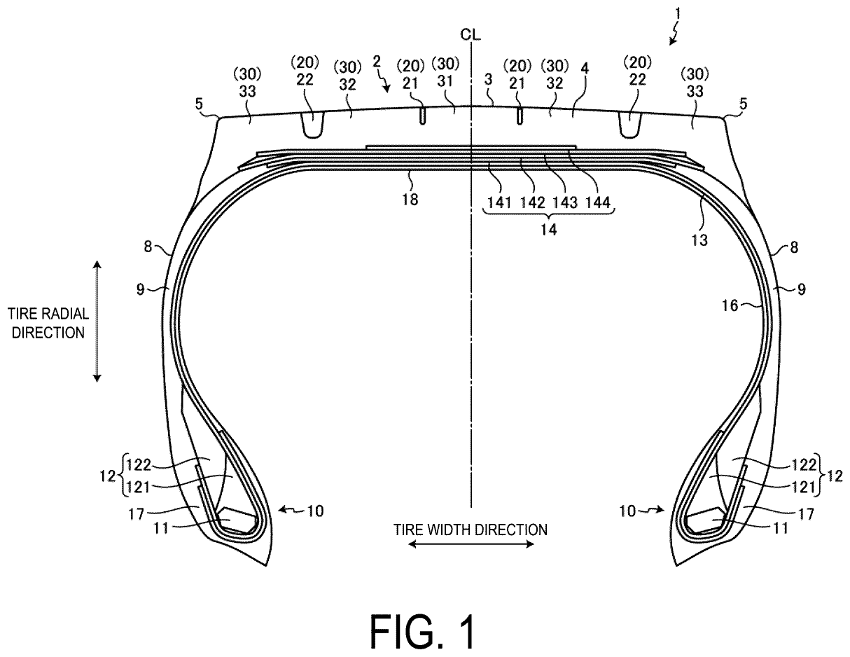

FIG. 1 is a tire meridian cross-sectional view illustrating a main portion of the pneumatic tire 1 according to an embodiment. FIG. 1 illustrates a meridional cross section of the pneumatic tire 1 according to an embodiment, the cross section of one side region of a tire rotation axis in a tire radial direction. In this embodiment, a heavy duty pneumatic radial tire mounted on a heavy-duty vehicle, such as a truck, a bus, and the like will be described as an example.

The pneumatic tire 1 according to this embodiment has a tread portion 2 disposed on a portion of the outermost side in the tire radial direction when seen from the tire meridian cross-section, and the tread portion 2 has a cap tread 4 made from rubber composition. A surface of the tread portion 2, i.e., a portion in contact with road surfaces during travel of a vehicle (not illustrated) on which the pneumatic tires 1 are mounted is formed as a tread ground contact surface 3, the tread ground contact surface 3 forming a portion of a contour of the pneumatic tire 1.

The cap tread 4 of the tread portion 2 forms the tread ground contact surface 3. The cap tread 4 has a rubber hardness Hs in a range of 60 or more and 70 or less, and a modulus M in a range of 8 MPa or more and 16 MPa or less at 300% elongation. The rubber hardness Hs is measured under a temperature condition of 20 °C in accordance with JIS (Japanese Industrial Standard) K6253. The modulus M is measured by a tensile test at a temperature of 20 °C using a dumbbell-shaped test piece in accordance with JIS K6251 (using a No.3 dumbbell).

Here, the rubber hardness Hs of the cap tread 4 is preferably in a range of 62 or more and 68 or less, and the modulus M at 300% elongation is preferably in a range of 11 MPa or more and 14 MPa or less.

Shoulder portions 5 are located at both ends on outer sides of the tread portion 2 in the tire width direction, and sidewall portions 8 are disposed on inner sides in the tire radial direction of the shoulder portions 5. In other words, the sidewall portions 8 are disposed on both sides in the tire width direction of the tread portion 2. In other words, the sidewall portions 8 are disposed at two sections on both sides of the pneumatic tire 1 in the tire width direction, forming exposed portions on the outermost sides of the pneumatic tire 1 in the tire width direction. The sidewall portion 8 has sidewall rubber 9 made from a rubber composition.

A bead portion 10 is provided on an inner side in the tire radial direction of each of the sidewall portions 8 located on both sides in the tire width direction. The bead portions 10 are disposed at two sections on both sides of the tire equatorial plane CL similar to the sidewall portions 8, i.e., a pair of the bead portions 10 are disposed on both sides of the tire equatorial plane CL in the tire width direction. Each of the bead portions 10 has a bead core 11 provided thereon, and a bead filler 12 is provided on an outer side of the bead core 11 in the tire radial direction.

The bead core 11 is an annular member formed into an annular shape by bundling and winding multiple time a bead wire that is a steel wire. The bead filler 12 has a lower filler 121 and an upper filler 122 that are rubber members and respectively disposed on the outer side of the bead core 11 in the tire radial direction to reinforce the bead portion 10.

Carcass layers 13 including cords of radial plies are continuously provided on the inner side of the tread portion 2 in the tire radial direction and the side of the tire equatorial plane CL of the sidewall portions 8. Therefore, the pneumatic tire 1 according to this embodiment is configured as a so-called radial tire. The carcass layer 13 has a single layer structure made of one carcass ply or a multilayer structure made of a plurality of carcass plies layered, and spans between the pair of bead portions 10 disposed on both sides in the tire width direction in a toroidal shape to form a backbone of the tire.

Specifically, the carcass layer 13 is disposed spanning from one bead portion 10 to the other bead portion 10 of the pair of bead portions 10 located on both sides in the tire width direction, and turned back on the outer side in the tire width direction along the bead cores 11 of the bead portions 10 in a manner wrapping the bead cores 11 and the bead fillers 12. The bead filler 12 is a rubber member disposed in a space on the outer side of the bead core 11 in the tire radial direction, the space being formed by folding the carcass layer 13 back at the bead portion 10. The carcass ply of the carcass layer 13 is formed by covering with coating rubber and performing a rolling process on a plurality of carcass cords made of steel. A plurality of rows of the carcass cords forming the carcass ply are disposed in parallel at an angle in the tire circumferential direction, the angle with respect to the tire circumferential direction lying along a tire meridian direction. Specifically, the angle of the carcass cords with respect to the tire circumferential direction is in a range of 80° or more and 90° or less in absolute values.

A belt layer 14 is disposed in the tread portion 2. The belt layer 14 is disposed on the outer side of a portion located in the tread portion in the tire radial direction 2, in the carcass layer 13 crosslinking the pair of bead portions 10. The belt layer 14 formed by layering a plurality of belt plies 141 to 144 is disposed in a manner wound around the outer circumference of the carcass layer 13. The belt plies 141 to 144 include a large-angle belt 141, a pair of cross belts 142 and 143, and a belt cover 144.

The large-angle belt 141 formed by covering with coating rubber and performing a rolling process on a plurality of belt cords made of steel, has a cord angle (defined as an inclination angle in the longitudinal direction of the belt cords with respect to the tire circumferential direction) of 45° or more and 70° or less in absolute values. The pair of cross belts 142 and 143 formed by covering, with coating rubber and performing a rolling process on a plurality of belt cords made of steel cords have a cord angle of 10° or more and 55° or less in absolute values. The pair of cross belts 142 and 143 have cord angles of mutually opposite signs and are layered by causing the belt cords to cross each other in the longitudinal direction of the belt cord (to have a so-called crossply structure). The belt cover 144 formed by covering with coating rubber and performing a rolling process on a plurality of belt cover cords made of steel or an organic fiber material has a cord angle of 10° or more and 55° or less in absolute values.

A rim cushion rubber 17 constituting a contact surface of the bead portion 10 with respect to a rim flange is disposed on the inner side in the tire radial direction and the outer side in the tire width direction of the bead core 11 and a turned back portion of the carcass layer 13 in the bead portion 10. An inner liner 16 is formed along the carcass layer 13 on the inner side of the carcass layer 13 or on the inner side of the carcass layer 13 in the pneumatic tire 1. The inner liner 16 forms a tire inner surface 18 that is a surface on the inner side of the pneumatic tire 1.

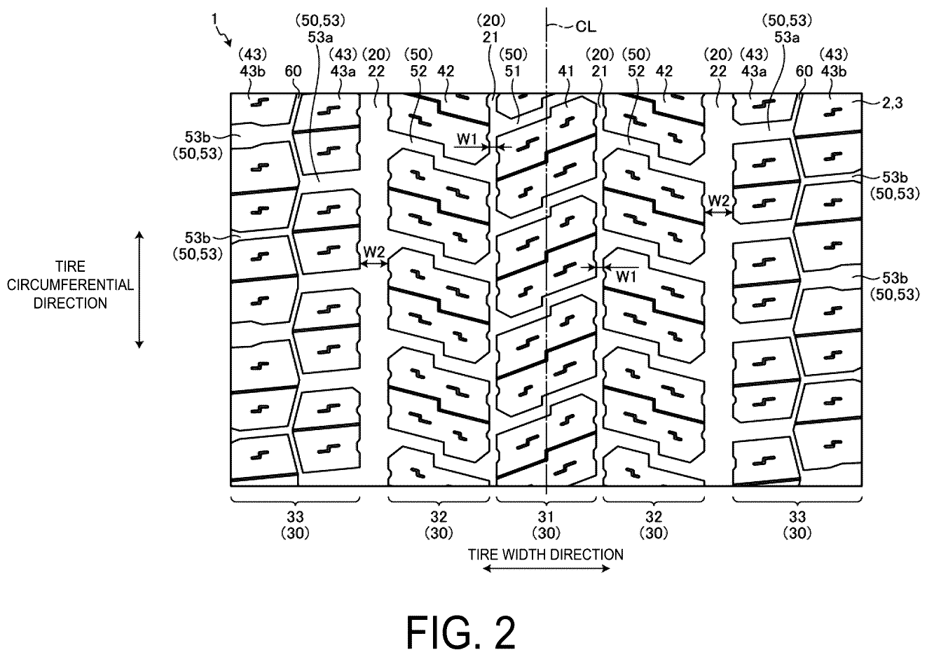

FIG. 2 is a plan view of the tread portion 2 illustrated in FIG. 1. The tread portion 2 has four circumferential grooves 20 extending in the tire circumferential direction disposed in the tread ground contact surface 3, with a plurality of land portion rows 30 defined on the surface of the tread portion 2 by the plurality of circumferential grooves 20. Two of the four circumferential grooves 20 are disposed on both sides of the tire equatorial plane CL in the tire width direction. Of the four circumferential grooves 20, two of the circumferential grooves 20 located on the inner side in the tire width direction are circumferential narrow grooves 21, and two of the circumferential grooves 20 located on the outer side of the circumferential narrow grooves 21 in the tire width direction are shoulder circumferential grooves 22.

The circumferential narrow groove 21 is formed to be the circumferential groove 20 extending in the tire circumferential direction with a groove width W1 in a range 1.5 mm≤W1≤5.0 mm. The groove width W1 of the circumferential narrow groove 21 is preferably in a range 1.5 mm≤W1≤3.0 mm. The groove width W2 of the shoulder circumferential groove 22 is larger than the groove width W1 of the circumferential narrow groove 21. In other words, the groove width W2 of the shoulder circumferential groove 22 satisfies a relationship W1<W2 with the groove width W1 of the circumferential narrow groove 21.

The shoulder circumferential groove 22 is provided as a main groove in the pneumatic tire 1 according to this embodiment. The main groove mentioned here is a longitudinal groove extending in the tire circumferential direction and including a wear indicator (slip sign) indicative of the terminal stage of wear. The shoulder circumferential groove 22 provided as the main groove has the groove width W2 in a range of 7 mm or more and 16 mm or less, and the groove depth in a range of 14 mm or more and 24 mm or less.

Here, each dimension in the tread pattern is measured in an unloaded state with the tire mounted on a specified rim and inflated with a specified internal pressure. Specified rim refers to “standard rim” specified in JATMA (The Japan Automobile Tyre Manufacturers Association, Inc.), “Design Rim” specified in TRA (The Tire and Rim Association, Inc.), or “MEASURING RIM” specified in ETRTO (The European Tyre and Rim Technical Organisation). Specified internal pressure refers to “maximum air pressure” specified in JATMA, the maximum value of “TIRE LOAD LIMITS AT VARIOUS COLD INFLATION PRESSURES” specified in TRA, or “INFLATION PRESSURES” specified in ETRTO. Specified load refers to “maximum load capacity” specified in JATMA, the maximum value of “TIRE LOAD LIMITS AT VARIOUS COLD INFLATION PRESSURES” specified in TRA, or “LOAD CAPACITY” specified in ETRTO.

The land portion row 30 has a center land portion row 31, a middle land portion row 32, and a shoulder land portion row 33. The center land portion row 31 is the land portion row 30 disposed at the closest position to the tire equatorial plane CL, both side in the tire width direction being defined by the circumferential narrow groove 21. Therefore, in this embodiment, the center land portion row 31 is disposed over the tire equatorial plane CL across the tire equatorial plane CL in the tire width direction.

The middle land portion row 32 is the land portion row 30 adjacent to the center land portion row 31 with the circumferential narrow groove 21 that is the circumferential groove 20 defining the center land portion row 31 interposed. The middle land portion row 32 has the inner side thereof in the tire width direction defined by the circumferential narrow groove 21 and the outer side thereof in the tire width direction defined by the shoulder circumferential groove 22. The middle land portion rows 32 thus formed are each disposed on both sides of the center land portion row 31 in the tire width direction, in other words, the middle land portion rows 32 are disposed on both sides of the tire equatorial plane CL in the tire width direction.

The shoulder land portion row 33 is a land portion row 30 located outermost in the tire width direction among the plurality of land portion rows 30 and adjacent to the middle land portion row 32 with the shoulder circumferential groove 22 that is the circumferential groove 20 defining the middle land portion row 32 interposed. The inner side of the shoulder land portion row 33 in the tire width direction is defined by the shoulder circumferential groove 22. In other words, the shoulder circumferential groove 22 is the circumferential groove 20 dividing the middle land portion row 32 and the shoulder land portion row 33. The shoulder land portion row 33 defined by the shoulder circumferential groove 22 is disposed on the outer side of the middle land portion row 32 in the tire width direction, and disposed on both sides of the tire equatorial plane CL in the tire width direction.

A lug groove 50 extending in the tire width direction and having both ends opening to the circumferential groove 20 is disposed in each of the center land portion row 31 and the middle land portion row 32. Accordingly, the center land portion row 31 has center blocks 41, both sides of which in the tire circumferential direction being defined by the lug groove 50, and the middle land portion row 32 has middle blocks 42, both sides of which in the tire circumferential direction being defined by the lug groove 50.

Specifically, in the center land portion row 31, a center lug groove 51 that is the lug groove 50, both ends of which in the longitudinal direction opening to the circumferential narrow groove 21 is disposed. Accordingly, the center land portion row 31 has a plurality of center blocks 41 arranged in the tire circumferential direction and both sides of which in the tire circumferential direction being defined by the center lug groove 51. In the middle land portion row 32, a middle lug groove 52 that is the lug groove 50, an inner end portion of which in the tire width direction opening to the circumferential narrow groove 21 and an outer end portion of which in tire width direction opening to the shoulder circumferential groove 22 is disposed. Accordingly, the middle land portion row 32 has a plurality of middle blocks 42 arranged in the tire circumferential direction and both sides of which in the tire circumferential direction being defined by the middle lug groove 52.

The center lug groove 51 and the middle lug groove 52 provided in the center land portion row 31 and the middle land portion row 32 as described above are inclined toward the tire circumferential direction with respect to the tire width direction while respectively extending in the tire width direction. The center lug groove 51 and the middle lug groove 52 are each bent at two positions while extending in the tire width direction, and formed into a so-called crank shape.

Inclination directions of the center lug groove 51 and the middle lug groove 52 in the tire circumferential direction with respect to the tire width direction are different from each other. In other words, the center lug groove 51 and the middle lug groove 52 disposed in the center land portion row 31 and the middle land portion row 32 which are adjacent to each other in the tire width direction have different inclination directions in the tire circumferential direction with respect to the tire width direction. On the other hand, the middle lug grooves 52 disposed in the middle land portion rows 32 at two positions across the center land portion row 31 have a same inclination direction in the tire circumferential direction with respect to the tire width direction.

In the shoulder land portion row 33, a shoulder narrow groove 60 extending in the tire width direction and a shoulder lug groove 53 that is a lug groove 50 extending in the tire width direction in the shoulder land portion row 33 are disposed. The shoulder narrow groove 60 is disposed at a position near the center of the shoulder land portion row 33 in the tire width direction. In this embodiment, the shoulder narrow groove 60 is repetitively bent in the tire circumferential direction while extending in the tire circumferential direction.

The shoulder lug groove 53 includes an inner shoulder lug groove 53a located on the inner side of the shoulder narrow groove 60 in the tire width direction, and an outer shoulder lug groove 53b located on the outer side of the shoulder narrow groove 60 in the tire width direction. The inner shoulder lug groove 53a has an inner end portion in the tire width direction opening to the shoulder circumferential groove 22, and an outer end portion in the tire width direction opening to the shoulder narrow groove 60. The outer shoulder lug groove 53b has an inner end portion in the tire width direction opening to the shoulder narrow groove 60, and an outer end portion in the tire width direction opening at a design end located at an outer end portion of the tread portion 2 in the tire width direction.

The inner shoulder lug groove 53a and the outer shoulder lug groove 53b are disposed at different positions in the tire circumferential direction. Specifically, the inner shoulder lug groove 53a and the outer shoulder lug groove 53b are alternately disposed in the tire circumferential direction. The outer shoulder lug groove 53b has two types of outer shoulder lug grooves 53b with different groove widths, the outer shoulder lug groove 53b with a narrow groove width and the outer shoulder lug groove 53b with a wide groove width are alternately disposed in the tire circumferential direction.

By disposing the shoulder lug grooves 53 extending in the tire width direction as described above, the shoulder land portion row 33 includes shoulder blocks 43, both sides of which in the tire circumferential direction are defined by the shoulder lug grooves 53. Specifically, inner shoulder blocks 43a that are the shoulder blocks 43 and both sides of which in the tire circumferential direction being defined by the inner shoulder lug groove 53a are disposed on the inner side in the tire width direction of the shoulder narrow groove 60 in the shoulder land portion row 33. Outer shoulder blocks 43b that are the shoulder blocks 43 and both sides of which in the tire circumferential direction being defined by the outer shoulder lug groove 53b are disposed on the outer side in the tire width direction of the shoulder narrow groove 60 in the shoulder land portion row 33.

Therefore, a plurality of inner shoulder blocks 43a are arranged in the tire circumferential direction on the inner side in the tire width direction of the shoulder narrow groove 60 in the shoulder land portion row 33, and a plurality of outer shoulder blocks 43b are arranged in the tire circumferential direction on the outer side in the tire width direction of the shoulder narrow groove 60 in the shoulder land portion row 33.

The shoulder lug groove 53 defining the shoulder blocks 43 in the shoulder land portion row 33 is inclined toward the tire circumferential direction with respect to the tire width direction while extending in the tire width direction. The inclination direction of the shoulder lug groove 53 in the tire circumferential direction with respect to the tire width direction is a direction opposite to the direction in which the middle lug groove 52 opening to the shoulder circumferential grooves 22 to which the shoulder lug grooves 53 opens is inclined in the tire circumferential direction with respect to the tire width direction. In other words, the inclination direction of the shoulder lug groove 53 in the tire circumferential direction with respect to the tire width direction is a direction identical to the inclination direction of the center lug groove 51 in the tire circumferential direction with respect to the tire width direction.

The inner shoulder lug groove 53a and the outer shoulder lug groove 53b included in the shoulder lug groove 53 have a same inclination direction in the tire circumferential direction with respect to the tire width direction. Therefore, the inclination directions in the tire circumferential direction with respect to the tire width direction of the inner shoulder lug groove 53a and the outer shoulder lug groove 53b are both a direction opposite to the inclination direction of the middle lug groove 52 in the tire circumferential direction with respect to the tire width direction.

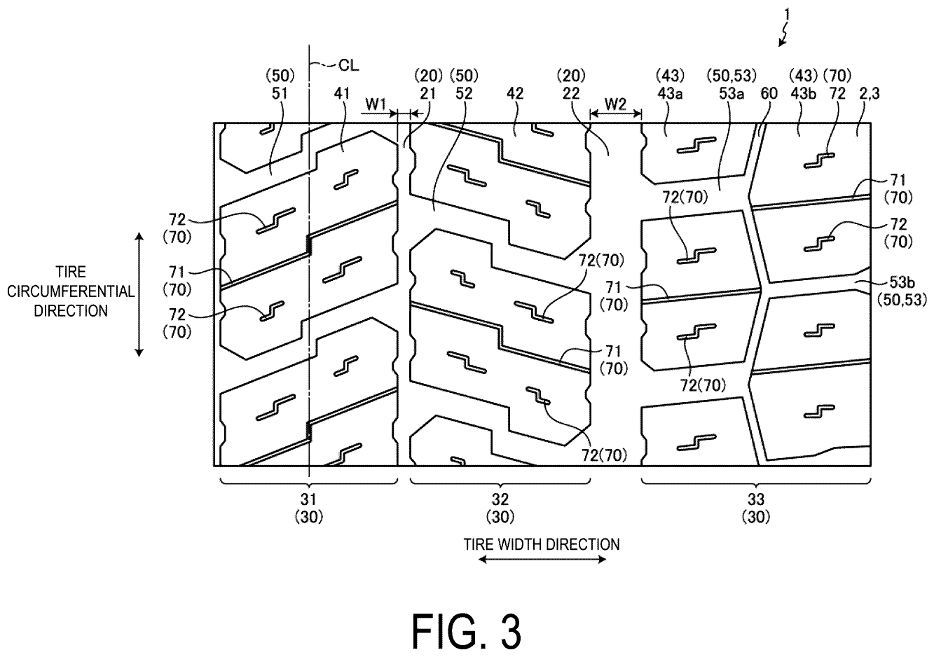

FIG. 3 is a detailed view of the tread portion 2 spanning from the center land portion row 31 to one of the shoulder land portion rows 33. An open sipe 71 that is a sipe 70 extending in the tire width direction and having both ends opening to the circumferential groove 20 is disposed in each of the center blocks 41 and the middle blocks 42. The open sipe 71 disposed in the center block 41 is disposed in each of the center blocks 41 and has both ends in the longitudinal direction opening to the circumferential narrow groove 21 similar to the center lug grooves 51. Accordingly, each of the center blocks 41 is divided in the tire circumferential direction by the open sipe 71. The open sipe 71 disposed in the center blocks 41 is inclined with respect to the tire width direction in the same direction as the direction in which the center lug groove 51 is inclined toward the tire circumferential direction with respect to the tire width direction. The inclination angle of the open sipe 71 disposed in the center blocks 41 with respect to the tire width direction is approximately the same as the inclination angle of the center lug grooves 51 with respect to the tire width direction.

The open sipe 71 disposed in the middle block 42 is disposed in each of the middle blocks 42, with the inner end portion in the longitudinal direction opening to the circumferential narrow groove 21, and the outer end portion opening to the shoulder circumferential groove 22 similar to the middle lug groove 52. Accordingly, each of the middle blocks 42 is divided in the tire circumferential direction by the open sipe 71. The open sipe 71 disposed in the middle block 42 is inclined with respect to the tire width direction in a same direction as the direction in which the middle lug groove 52 is inclined toward the tire circumferential direction with respect to the tire width direction. The inclination angle of the open sipe 71 disposed in the middle block 42 with respect to the tire width direction is approximately the same as the inclination angle of the middle lug grooves 52 with respect to the tire width direction.

The open sipe 71 disposed in the center block 41 and the open sipe 71 disposed in the middle blocks 42 are bent at two positions while extending in the tire width direction and formed into a so-called crank shape similar to the center lug grooves 51 and the middle lug grooves 52.

The open sipe 71 is also disposed in the inner shoulder block 43a and the outer shoulder block 43b included in the shoulder land portion row 33. The open sipe 71 disposed in the inner shoulder block 43a are disposed in each of the inner shoulder blocks 43a, with the inner end portions in the longitudinal direction opening to the shoulder circumferential groove 22, and the outer end portions opening to the shoulder narrow groove 60 similar to the inner shoulder lug groove 53a. Accordingly, each of the inner shoulder blocks 43a is divided in the tire circumferential direction by the open sipe 71.

The open sipe 71 disposed in the outer shoulder block 43b is disposed in each of the outer shoulder blocks 43b, with the inner end portion in the longitudinal direction opening to the shoulder narrow groove 60, and the outer end portion opening to the design end similar to the outer shoulder lug groove 53b. Accordingly, each of the outer shoulder blocks 43b is divided in the tire circumferential direction by the open sipe 71.

The open sipes 71 disposed in the inner shoulder block 43a and the outer shoulder block 43b are inclined with respect to the tire width direction in the same direction as the direction in which the inner shoulder lug groove 53a and the outer shoulder lug groove 53b are inclined toward the tire circumferential direction with respect to the tire width direction. The inclination angle of the open sipes 71 disposed in the inner shoulder block 43a and the outer shoulder block 43b with respect to the tire width direction is approximately the same as the inclination angle of the inner shoulder lug groove 53a and the outer shoulder lug groove 53b with respect to the tire width direction.

In the center blocks 41, the middle blocks 42, the inner shoulder blocks 43a, and the outer shoulder blocks 43b, the closed sipes 72 that are the sipes 70, both ends of which terminating in each of the blocks are disposed. Specifically, the closed sipe 72 disposed in the center blocks 41 are disposed, two on both sides in the tire circumferential direction of the open sipes 71 disposed in the center blocks 41, both ends of each of the closed sipes 72 terminating in the center blocks 41. The closed sipes 72 disposed in the middle blocks 42 are disposed, two on both sides in the tire circumferential direction of the open sipes 71 disposed in the middle blocks 42, both ends of each of the closed sipes 72 terminating in the middle blocks 42.

The closed sipe 72 disposed in the inner shoulder block 43a is disposed on each side in the tire circumferential direction of the open sipe 71 arranged in the inner shoulder block 43a, both ends of each of the closed sipes 72 terminating in the inner shoulder block 43a. The closed sipe 72 disposed in the outer shoulder block 43b is disposed on each side in the tire circumferential direction of the open sipe 71 disposed in the outer shoulder block 43b, both ends of each of the closed sipes 72 terminating in the outer shoulder block 43b. Each of the closed sipes 72 disposed in each block as described above is formed into a crank shape by bending at two positions while extending in the tire width direction at an angle which is substantially parallel to the lug grooves 50 defining the blocks.

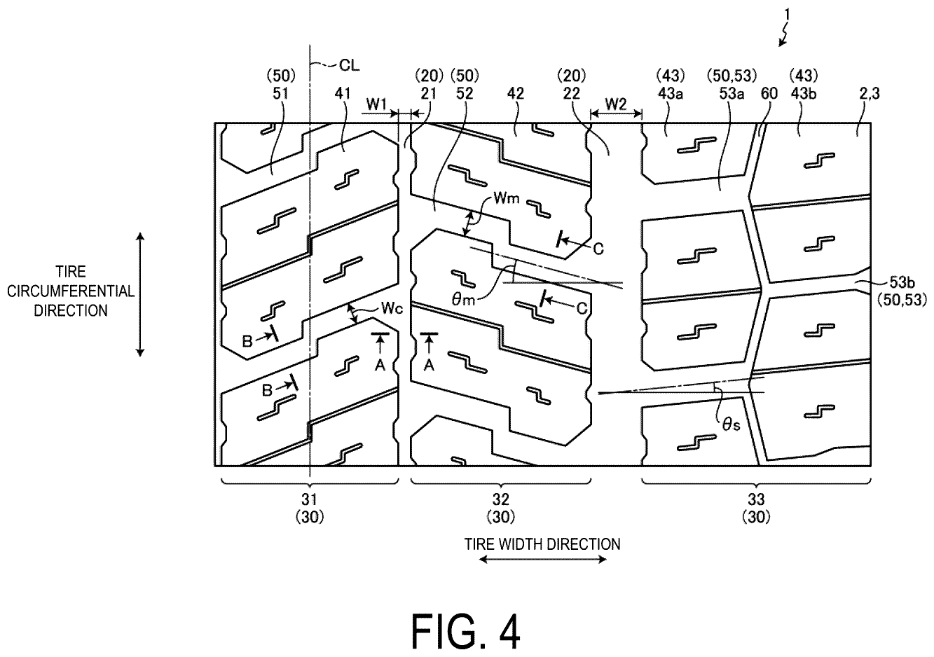

FIG. 4 is an explanatory diagram of each of the lug grooves 50 illustrated in FIG. 3. The groove width Wc of the center lug groove 51 that is the lug groove 50 defining the center blocks 41 satisfies a relationship W1≤Wc with the groove width W1 of the circumferential narrow groove 21. The groove width Wm of the middle lug groove 52 that is the lug groove 50 defining the middle blocks 42 satisfies a relationship W1≤Wm with the groove width W1 of the circumferential narrow groove 21. Specifically, the ratio of the groove width Wc of the center lug groove 51 to the groove width W1 of the circumferential narrow groove 21 is in a range 1≤Wc/W1≤5, and the ratio of the groove width Wm of the middle lug groove 52 to the groove width W1 of the circumferential narrow groove 21 is in a range 1≤Wm/W1≤5.

Here, the groove width Wc of the center lug groove 51 and the groove width Wm of the middle lug groove 52 in this case are groove widths of portions other than chamfers when chamfers are formed at opening portions of the center lug groove 51 and the middle lug groove 52 with respect to the circumferential groove 20 as illustrated in FIG. 4. The ratio of the groove width Wc of the center lug groove 51 to the groove width W1 of the circumferential narrow groove 21 is preferably in a range 2≤Wc/W1≤4, and the ratio of the groove width Wm of the middle lug groove 52 to the groove width W1 of the circumferential narrow groove 21 is preferably in a range 2≤Wm/W1≤4.

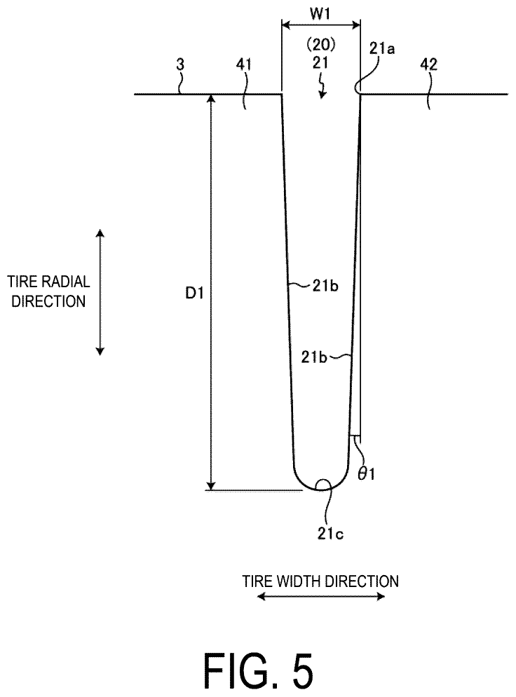

FIG. 5 is a cross-sectional view taken along A-A of FIG. 4. The groove depth W1 and the groove depth D1 of the circumferential narrow groove 21 disposed between the center blocks 41 and the middle blocks 42 satisfy a relationship 4≤D1/W1≤14. Here, the relationship between the groove width W1 and the groove depth D1 of the circumferential narrow groove 21 is preferably in a range 7≤D1/W1≤14.

The circumferential narrow groove 21 is formed so that the groove width is constant toward the side of a groove bottom 21c from the side of an opening portion 21a to the tread ground contact surface 3, or the groove width becomes narrower toward the side of the groove bottom 21c. Specifically, as for the circumferential narrow groove 21, an inclination angle θ1 of a groove wall 21b with respect to the direction of the groove depth of the circumferential narrow groove 21 is in a range 0°≤θ1≤3°. The inclination angle θ1 of the groove wall 21b in this case is an angle in a case where the inclination angle of the groove wall 21b is positive when the groove wall 21b is inclined in a direction in which the groove width becomes narrower toward the side of the groove bottom 21c of the circumferential narrow groove 21 from the side of the opening portion 21b of the circumferential narrow groove 21 to the tread ground contact surface 3.

Here, the inclination angle θ1 of the groove wall 21b of the circumferential narrow groove 21 is preferably in a range 0°≤θ1≤2°. The groove width W1 of the circumferential narrow groove 21 is a groove width at the position of the opening portion 21a.

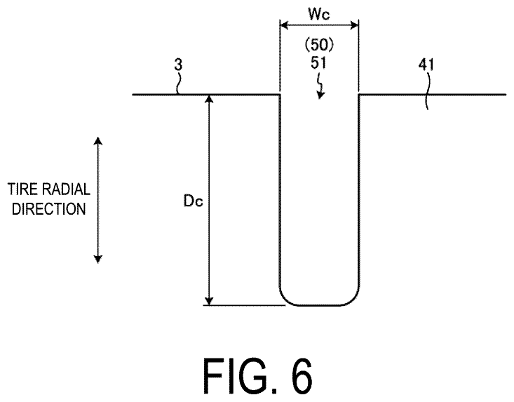

FIG. 6 is a cross-sectional view taken along B-B of FIG. 4. The ratio of the groove depth Dc of the center lug groove 51 disposed in the center land portion row 31 to the groove depth D1 of the circumferential narrow groove 21 is in a range 0.5≤Dc/D1≤0.9. The ratio of the groove depth Dc of the lug groove center portion 51 to the groove depth D1 of the circumferential narrow groove 21 is preferably in a range 0.6≤Dc/D1≤0.8.

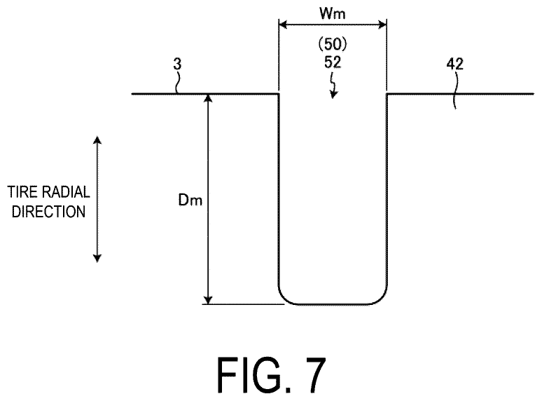

FIG. 7 is a cross-sectional view taken along C-C of FIG. 4. The ratio of a groove depth Dm of the middle lug groove 52 disposed in the middle land portion row 32 to the groove depth D1 of the circumferential narrow groove 21 is in a range 0.5≤Dm/D1≤0.9. The ratio of the groove depth Dm of the middle lug groove 52 to the groove depth D1 of the circumferential narrow groove 21 is preferably in a range 0.6≤Dm/D1≤0.8.

The ratio of a sipe depth Dco (not illustrated) of the open sipe 71 (see FIG. 3) disposed in the center blocks 41 to the groove depth D1 of the circumferential narrow groove 21 is in a range 0.5≤Dco/D1≤0.8. The ratio of a sipe depth Dmo (not illustrated) of the open sipe 71 (see FIG. 3) disposed in the middle blocks 42 to the groove depth D1 of the circumferential narrow groove 21 is in a range 0.5≤Dmo/D1≤0.8.

Here, the ratio of the sipe depth Dco of the open sipes 71 disposed in the center blocks 41 to the groove depth D1 of the circumferential narrow groove 21, and the ratio of the sipe depth Dmo of the open sipes 71 disposed in the middle blocks 42 to the groove depth D1 of the circumferential narrow groove 21 are preferably in ranges 0.5≤Dco/D1≤0.7 and 0.5≤Dmo/D1≤0.7.

The ratio of a sipe depth Dcc (not illustrated) of the closed sipe 72 (see FIG. 3) disposed in the center blocks 41 to the groove depth D1 of the circumferential narrow groove 21 is in a range 0.5≤Dcc/D1≤0.9. The ratio of a sipe depth Dmc (not illustrated) of the closed sipe 72 (see FIG. 3) disposed in the middle blocks 42 to the groove depth D1 of the circumferential narrow groove 21 is in a range 0.5≤Dmc/D1≤0.9.

Here, the ratio of the sipe depth Dcc of the closed sipe 72 disposed in the center blocks 41 to the groove depth D1 of the circumferential narrow groove 21, and the ratio of the sipe depth Dmc of the closed sipe 72 disposed in the middle blocks 42 to the groove depth D1 of the circumferential narrow groove 21 are preferably in ranges 0.6≤Dcc/D1≤0.8 and 0.6≤Dmc/D1≤0.8, respectively.

The middle lug groove 52 and the shoulder lug groove 53 having different inclination directions in the tire circumferential direction with respect to the tire width direction, also have different inclination angles with respect to the tire width direction, the inclination angle Om of the middle lug groove 52 with respect to the tire width direction being larger than the inclination angle θs of the shoulder lug groove 53 with respect to the tire width direction. In other words, as for the middle lug grooves 52 and the shoulder lug grooves 53, the inclination angle θs of the shoulder lug groove 53 toward the tire circumferential direction with respect to the tire width direction, and the inclination angle θm of the middle lug groove 52 toward the tire circumferential direction with respect to the tire width direction satisfy a relationship θs<θm.

Note that the inclination angle θm of the middle lug groove 52 and the inclination angle θs of the shoulder lug groove 53 mentioned here are angles at the groove width center of the middle lug groove 52 and the shoulder lug groove 53. Although the middle lug groove 52 is formed into a crank shape, and the shoulder lug groove 53 has the inner shoulder lug groove 53a and the outer shoulder lug groove 53b, the inclination angle θm of the middle lug groove 52 and the inclination angle θs of the shoulder lug groove 53 in this case are angles of portions of the middle lug groove 52 and the shoulder lug groove 53 opening to the same shoulder circumferential groove 22. Therefore, as for the middle lug groove 52 and the shoulder lug groove 53, the inclination angle θm of a portion of the middle lug groove 52 opening to the shoulder circumferential groove 22 and the inclination angle θs of the inner shoulder lug groove 53a of the shoulder lug groove 53 opening to the same shoulder circumferential groove 22 satisfy a relationship θs<θm.

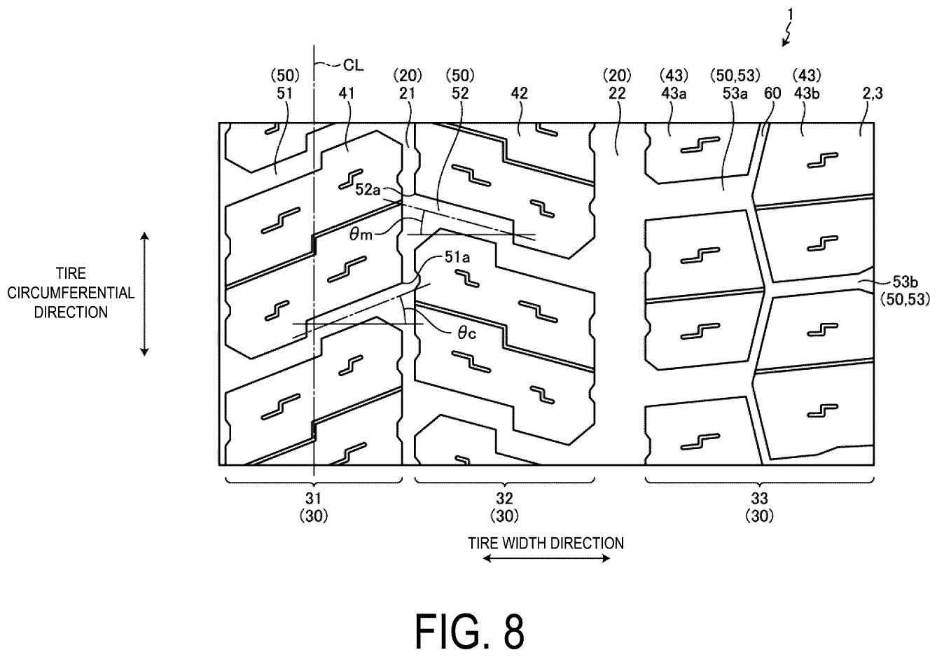

FIG. 8 is an explanatory view of the center lug groove 51 and the middle lug groove 52 illustrated in FIG. 3. The center lug groove 51 and the middle lug groove 52 inclined toward different directions in the tire circumferential direction with respect to the tire width direction are each inclined in a range of 10° or more and 25° or less in the tire circumferential direction with respect to the tire width direction. In other words, an inclination angle θc of the center lug groove 51 in the tire circumferential direction with respect to the tire width direction is in a range 10°≤θc≤25°, and an inclination angle Om of the middle lug groove 52 in the tire circumferential direction with respect to the tire width direction is in a range 10°≤θm≤25°.

Note that the inclination angle θc of the center lug groove 51 and the inclination angle θm of the middle lug groove 52 mentioned here are angles at the groove width center of the center lug groove 51 and the middle lug groove 52. Although the center lug groove 51 and the middle lug groove 52 are each formed into a crank shape, the inclination angle θc of the center lug groove 51 and the inclination angle Om of the middle lug groove 52 in this case are angles of portions of the center lug groove 51 and the middle lug groove 52 opening to the same circumferential narrow groove 21. Therefore, as for the center lug groove 51 and the middle lug groove 52, the inclination angle θc of a portion of the center lug groove 51 opening to the circumferential narrow groove 21 and the inclination angle θm of a portion of the middle lug groove 52 opening to the circumferential narrow groove 21 are in ranges 10°<θc≤25° and 10°<θm<25°, respectively.

The center lug groove 51 and the middle lug groove 52 are formed as described above, and respectively open to the circumferential narrow groove 21 from different sides in the groove width direction. As for the center lug groove 51 and the middle lug groove 52 opening to the same circumferential narrow groove 21, opening portions 51a of the center lug groove 51 with respect to the circumferential narrow groove 21 and opening portions 52b of the middle lug groove 52 with respect to the circumferential narrow groove 21 are alternately disposed in the tire circumferential direction. In other words, the opening portion 51a of the center lug groove 51 with respect to the circumferential narrow groove 21 and the opening portion 52b of the middle lug groove 52 with respect to the circumferential narrow groove 21 do not face each other, and are disposed in a mutually staggered manner in the tire circumferential direction.

When mounting the pneumatic tire 1 according to this embodiment to a vehicle, the pneumatic tire 1 is mounted on a rim wheel and inflated with air inside to an inflated state, and then mounted to the vehicle. When the vehicle on which the pneumatic tires 1 are mounted travels, the pneumatic tire 1 rotates with a lower portion of the tread ground contact surface 3 of the tread portion 2 in contact with a road surface. When the vehicle on which the pneumatic tires 1 are mounted travels on a dry road surface, the vehicle travels mainly by transmitting driving force and braking force to the road surface and generating turning force by the friction force between the tread ground contact surface 3 and the road surface.

When traveling on a wet road surface, water between the tread ground contact surface 3 and the road surface may enter a groove such as the shoulder circumferential groove 22, the circumferential narrow groove 21, or the lug groove 50, the vehicle may travel while draining the water between the tread ground contact surface 3 and the road surface by such grooves. The foregoing allows the tread ground contact surface 3 to easily contact the road surface and allows the vehicle to travel by friction force between the tread ground contact surface 3 and the road surface.

When traveling on a snow-covered road surface, the pneumatic tire 1 presses and compacts snow on the road surface with the tread ground contact surface 3 and, due to the snow on the road surface entering the circumferential groove 20 or the lug groove 50, such snow is also pressed and compacted inside the groove. When, in this state, driving force or braking force acts on the pneumatic tire 1, or turning of the vehicle applies a force in the tire width direction, a so-called snow column shear force that is a shear force acting on the snow inside the groove is generated between the pneumatic tire 1 and the snow. When traveling on a snow-covered road surface, generation of resistance between the pneumatic tire 1 and the road surface due to the snow column shear force allows for transmitting driving force and braking force to the road surface, whereby snow traction properties can be ensured. The foregoing allows the vehicle to travel on a snow-covered road surface.

When traveling on a snow-covered road surface or an ice-covered road surface, the vehicle travels using also edge effects of the circumferential groove 20, the lug groove 50, and the sipe 70. In other words, when traveling on a snow-covered road surface or an ice-covered road surface, the vehicle travels using also resistance due to catching of snowy or icy surfaces by the edge of the circumferential groove 20, the edge of the lug groove 50, or the edge of the sipe 70. When traveling on an ice-covered road surface, absorbing water from the ice-covered road surface by the sipe 70 to remove water film between the ice-covered road surface and the tread ground contact surface 3 facilitates contact between the ice-covered road surface and the tread ground contact surface 3. Accordingly, the resistance between the tread ground contact surface 3 and the ice-covered road surface increases due to the frictional force and the edge effect, which allows for ensuring the running performance of the vehicle having the pneumatic tires 1 mounted thereon.

The tread portion 2 has the center land portion row 31, the middle land portion row 32, and the shoulder land portion row 33 defined by the plurality of circumferential grooves 20, and the circumferential groove 20 disposed between the center land portion row 31 and the middle land portion row 32 is the circumferential narrow groove 21, whereby rigidity of the center land portion row 31 and the middle land portion row 32 can be ensured. In other words, closing the circumferential narrow groove 21 when the center land portion row 31 and the middle land portion row 32 are in ground contact to apply a load on the land portion rows 30 allows the circumferential narrow groove 21 to bring in contact the center land portion row 31 and the middle land portion row 32 defined by the circumferential narrow groove 21. Therefore, the land portion rows 30 can support each other when the center land portion row 31 and the middle land portion row 32 are in ground contact, whereby the rigidity of the center land portion row 31 and the middle land portion row 32 can be enhanced. Accordingly, it is possible to ensure the rigidity of the portion of the tread portion 2 near the center in the tire width direction, which is likely to receive a large load during travel of the vehicle. Therefore, it is possible to suppress deformation of the land portion row 30 during travel of the vehicle, whereby the rolling resistance caused by deformation of the land portion row 30 can be reduced.

On this occasion, since the groove width W1 of the circumferential narrow groove 21 is in a range 1.5 mm≤W1≤5.0 mm, it is possible to reduce the rolling resistance while ensuring wet performance that is the running performance on wet road surfaces and on-snow performance that is the running performance on snow-covered road surfaces. In other words, when the groove width W1 of the circumferential narrow groove 21 satisfies W1<1.5 mm, the groove width W1 is too narrow, and almost no water or snow on the road surface may enter the circumferential narrow groove 21 while traveling on a wet road surface or traveling on a snow-covered road surface. In this case, it may be difficult to improve the running performance on wet road surfaces or on snow-covered road surfaces by the circumferential narrow groove 21, even when the circumferential narrow groove 21 is disposed in the tread portion 2. When the groove width W1 of the circumferential narrow groove 21 is in a range of W1>5.0 mm, the groove width W1 is too wide, and thus the circumferential narrow groove 21 may become difficult to close even when a load is applied to the center land portion row 31 or the middle land portion row 32, and the center land portion row 31 and the middle land portion row 32 may become difficult to contact each other. In this case, when the center land portion row 31 and the middle land portion row 32 are in ground contact, the land portion rows 30 can no longer support each other, which makes it difficult to suppress deformation of the land portion rows 30 during travel of the vehicle and difficult to reduce the rolling resistance.

In contrast, when the groove width W1 of the circumferential narrow groove 21 is in a range 1.5 mm≤W1≤5.0 mm, it is possible to set an appropriate groove width so that the center land portion row 31 and the middle land portion row 32 can be brought into contact to support each other when a load is applied to the center land portion row 31 and the middle land portion row 32, while ensuring a groove width that allows water and snow on the road surface to enter the circumferential narrow groove 21 during travel on a wet road surface or a snow-covered road surface. Accordingly, it is possible to reduce the rolling resistance by suppressing deformation of the land portion row 30 due to the load applied near the center in the tire width direction, while ensuring wet performance and on-snow performance.

Since the relationship between the groove width W1 and the groove depth D1 of the circumferential narrow grooves 21 satisfies 4≤D1/W1≤14, it is possible to reduce the rolling resistance while ensuring the wet performance and on-snow performance. In other words, when the relationship between the groove depth W1 and the groove depth D1 of the circumferential narrow groove 21 is D1/W1<4, the groove depth W1 relative to the groove depth D1 is too small, and thus the circumferential narrow groove 21 may become difficult to close even when a load is applied to the land portion row 30 defined by the circumferential narrow groove 21. In this case, the land portion rows 30 can no longer support each other when the land portion rows 30 defined by the circumferential narrow grooves 21 is in ground contact, thus it becomes difficult to suppress deformation of the land portion row 30 during travel of the vehicle, and it may become difficult to reduce the rolling resistance. When the relationship between the groove depth W1 and the groove depth D1 of the circumferential narrow groove 21 is D1/W1>14, the groove depth W1 relative to the groove depth D1 is too large, and thus the circumferential narrow groove 21 may become too easy to close when a load is applied to the land portion row 30 defined by the circumferential narrow groove 21. In this case, closing of the circumferential narrow groove 21 when the land portion row 30 is in ground contact makes it difficult for water or snow on a road surface during travel on a wet road surface or a snow-covered road surface to enter the circumferential narrow groove 21, and thus it may become difficult to improve the wet performance or on-snow performance by the circumferential narrow groove 21 even when the circumferential narrow groove 21 is disposed in the tread portion 2.

In contrast, when the relationship between the groove width W1 and the groove depth D1 of the circumferential narrow groove 21 satisfies 4≤D1/W1≤14, the circumferential narrow groove 21 can be appropriately closed to an extent that the land portion rows 30 can support each other when the land portion row 30 is in ground contact, by suppressing the circumferential narrow groove 21 from becoming too easy to close and allowing water or snow on the road surface to appropriately enter the circumferential narrow groove 21. Accordingly, it is possible to reduce the rolling resistance by suppressing deformation of the land portion row 30 due to the load applied near the center in the tire width direction, while ensuring wet performance and on-snow performance.

Since the relationship between the groove width W2 of the shoulder circumferential grooves 22 that partition the middle land portion row 32 and the shoulder land portion rows 33 and the groove width W1 of the circumferential narrow groove 21 satisfies W1<W2, a larger amount of snow can enter the shoulder circumferential groove 22 during travel on snow-covered road surfaces, whereby snow column shear force can be ensured. Accordingly, it is possible to ensure on-snow performance by the shoulder circumferential groove 22 having a wide groove width, while reducing the rolling resistance by the circumferential narrow groove 21 having a narrow groove width.

Since the groove width Wc of the center lug groove 51 defining the center blocks 41 disposed in the center land portion row 31 satisfies the relationship W1≤Wc with the groove width W1 of the circumferential narrow groove 21, and the groove width Wm of the middle lug grooves 52 defining the middle blocks 42 disposed in the middle land portion row 32 satisfies the relationship W1≤Wm with the groove width W1 of the circumferential narrow groove 21, it becomes easy to generate snow column shear force by the snow entering the center lug groove 51 or the middle lug groove 52. In other words, the groove width Wc of the center lug groove 51 satisfies W1>Wc with the groove width W1 of the circumferential narrow groove 21, or the groove width Wm of the middle lug groove 52 satisfies W1>Wm with the groove width W1 of the circumferential narrow groove 21, the groove width Wc of the center lug groove 51 and the groove width Wm of the middle lug grooves 52 are too narrow, and therefore the amount of snow entering the center lug groove 51 and the middle lug groove 52 may decrease during travel on snow-covered road surfaces. In this case, it may become difficult to generate snow column shear force by the snow entering the center lug groove 51 and the middle lug groove 52.

In contrast, when the groove width Wc of the center lug groove 51 satisfies the relationship W1≤Wc with the groove width W1 of the circumferential narrow groove 21, and the groove width Wm of the middle lug groove 52 satisfies the relationship W1≤Wm with the groove width W1 of the circumferential narrow groove 21, it is possible to allow a larger amount of snow to enter the center lug groove 51 and the middle lug groove 52 during travel on snow-covered road surfaces. Accordingly, it is possible to generate snow column shear force easier by the snow entering the center lug groove 51 and the middle lug groove 52, whereby on-snow performance can be ensured.

The inclination angle θs of the shoulder lug groove 53 disposed in the shoulder land portion rows 33 in the tire circumferential direction with respect to the tire width direction and the inclination angle θm of the middle lug groove 52 disposed in the middle land portion row 32 in the tire circumferential direction with respect to the tire width direction satisfy the relationship θs<θm, whereby on-snow performance can be improved. In other words, it has become easier to apply a relatively large load to the middle land portion row 32 than the shoulder land portion row 33 during travel of the vehicle, and it is easier to exert the edge effect of the middle lug groove 52 disposed in the middle land portion row 32 than the edge effect of the shoulder lug groove 53 disposed in the shoulder land portion row 33. Therefore, the relationship between the inclination angle θm of the middle lug groove 52 disposed in the middle land portion row 32 and the inclination angle θs of the shoulder lug groove 53 satisfies θs<θm, and the edge component with respect to the tire width direction is ensured by the middle lug groove 52, so that the edge effect in the tire width direction can be effectively enhanced. Accordingly, it is possible to increase the edge effect in the tire width direction during travel on a snow-covered road surface, whereby the turning performance during travel on a snow-covered road surface can be enhanced to ensure the steering stability.

On the other hand, during braking and driving of the vehicle, the ground contact pressure near both ends in the tire width direction is likely to increase, and therefore the edge effect of the shoulder lug groove 53 disposed in the shoulder land portion rows 33 is likely to exhibit a greater effect during braking and driving of the vehicle. Therefore, the relationship between the inclination angle θm of the middle lug groove 52 disposed in the middle land portion row 32 and the inclination angle θs of the shoulder lug groove 53 satisfies θs<θm, and the edge component with respect to the tire circumferential direction at the positions near both ends in the tire width direction is ensured by the shoulder lug groove 53, so that the edge effect in the tire circumferential direction during braking and driving of the vehicle can be effectively enhanced. Accordingly, it is possible to increase the edge effect in the tire circumferential direction during braking and driving on a snow-covered road surface, and to improve the traction performance during travel on a snow-covered road surface. The foregoing allows for improving the snow traction properties during travel on snow-covered road surfaces and improving on-snow performance.

Furthermore, since the open sipes 71 that are the sipes 70 both ends of which open to the circumferential groove 20 are respectively disposed in the center blocks 41 disposed in the center land portion row 31 and the middle blocks 42 disposed in the middle land portion row 32, it is possible to increase the edge component by the open sipes 71 while suppressing decrease of the rigidity of the center land portion row 31 and the middle land portion row 32. Therefore, it is possible to ensure on-snow performance by the edge component of the open sipes 71 while reducing rolling resistance by suppressing deformation of the center land portion row 31 and the middle land portion row 32. As a result of the foregoing, it is possible to reduce the rolling resistance while suppressing decrease of on-snow performance.

Since the ratio of the groove width Wc of the center lug groove 51 to the groove width W1 of the circumferential narrow groove 21 is in a range 1≤Wc/W1≤5, and the ratio of the groove width Wm of the middle lug groove 52 is in a range 1≤Wm/W1≤5, it is possible to reduce the rolling resistance while suppressing decrease of on-snow performance more reliably. In other words, when the ratio of the groove width Wc of the center lug groove 51 to the groove width W1 of the circumferential narrow groove 21 is Wc/W1<1, or when the ratio of the groove width Wm of the middle lug groove 52 is Wm/W1<1, the groove width Wc of the center lug groove 51 or the groove width Wm of the middle lug groove 52 may become too narrow. In this case, although rolling resistance can be reduced by ensuring the rigidity of the center blocks 41 and the middle blocks 42, the amount of snow entering the center lug groove 51 and the middle lug groove 52 during travel on snow-covered road surfaces is reduced, and it becomes difficult to ensure snow column shear force, it may become difficult to improve on-snow performance. When the ratio of the groove width Wc of the center lug groove 51 to the groove width W1 of the circumferential narrow groove 21 is Wc/W1>5, or the ratio of the groove width Wm of the middle lug groove 52 is Wm/W1>5, the groove width Wc of the center lug groove 51 and the groove width Wm of the middle lug groove 52 may become too wide. In this case, while the amount of snow that enters the center lug groove 51 and the middle lug groove 52 during travel on snow-covered road surfaces increases, and snow column shear force is easily ensured, and therefore on-snow performance is easily improved, rigidity of the center blocks 41 and the middle blocks 42 may decrease so that they may easily deform, whereby rolling resistance may easily deteriorate.

In contrast, when the ratio of the groove width Wc of the center lug groove 51 to the groove width W1 of the circumferential narrow groove 21 is in a range 1≤Wc/W1≤5, and the ratio of the groove width Wm of the middle lug groove 52 is in a range 1≤Wm/W1≤5, snow can easily enter the center lug groove 51 and the middle lug groove 52 during travel on snow-covered road surfaces, and snow column shear force can be easily increased, while ensuring the rigidity of the center blocks 41 and the middle blocks 42 and suppressing the blocks from becoming easily deformed. As a result of the foregoing, it is possible to reduce the rolling resistance while suppressing decrease of on-snow performance more reliably.

Since the ratio of the groove depth Dc of the center lug groove 51 to the groove depth D1 of the circumferential narrow groove 21 is in a range 0.5≤Dc/D1≤0.9, and the ratio of the groove depth Dm of the middle lug groove 52 is in a range 0.5≤Dm/D1≤0.9, it is possible to reduce the rolling resistance while suppressing decrease of on-snow performance more reliably. In other words, when the ratio of the groove depth Dc of the center lug groove 51 to the groove depth D1 of the circumferential narrow groove 21 is Dc/D1<0.5 or the ratio of the groove depth Dm of the middle lug groove 52 is Dm/D1<0.5, the groove depth Dc of the center lug groove 51 or the groove depth Dm of the middle lug groove 52 may become too shallow. In this case, the amount of snow that enters the center lug groove 51 and the middle lug groove 52 during travel on snow-covered road surfaces is reduced, making it difficult to ensure snow column shear force, and therefore it may become difficult to improve on-snow performance. When the ratio of the groove depth Dc of the center lug groove 51 to the groove depth D1 of the circumferential narrow groove 21 is Dc/D1>0.9, or the ratio of the groove depth Dm of the middle lug groove 52 is Dm/D1>0.9, the groove depth Dc of the center lug groove 51 or the groove depth Dm of the middle lug groove 52 may become too deep. In this case, rigidity of the center blocks 41 and the middle blocks 42 may decrease so that they may easily deform, whereby rolling resistance may easily deteriorate.

In contrast, when the ratio of the groove depth Dc of the center lug groove 51 to the groove depth D1 of the circumferential narrow groove 21 is in a range 0.5<Dc/D1<0.9, and the ratio of the groove depth Dm of the middle lug groove 52 is in a range 0.5≤Dm/D1≤0.9, snow can easily enter the center lug groove 51 and the middle lug groove 52 during travel on snow-covered road surfaces and snow column shear force can easily be increased while ensuring the rigidity of the center blocks 41 and the middle blocks 42 and suppressing the blocks from being easily deformed. As a result of the foregoing, it is possible to reduce the rolling resistance while suppressing decrease of on-snow performance more reliably.

Since the ratio of the sipe depth Dco of the open sipes 71 disposed in the center blocks 41 to the groove depth D1 of the circumferential narrow groove 21 is in a range 0.5≤Dco/D1≤0.8, and the ratio of the sipe depth Dmo of the open sipes 71 disposed in the middle blocks 42 is in a range 0.5≤Dmo/D1≤0.8, it is possible to reduce the rolling resistance while suppressing decrease of on-snow performance more reliably. In other words, when the ratio of the sipe depth Dco of the open sipes 71 disposed in the center blocks 41 to the groove depth D1 of the circumferential narrow groove 21 is Dco/D1<0.5, or when the ratio of the sipe depth Dmo of the open sipes 71 disposed in the middle blocks 42 is Dmo/D1 <0.5, the sipe depth Dco and Dmo may become too shallow. In this case, even when a load is applied to the center blocks 41 or the middle blocks 42, deformation of the blocks becomes too small, whereby the edge of the open sipes 71 is difficult to rise, making it difficult to obtain the edge effect of the open sipes 71 and to improve on-snow performance. When the ratio of the sipe depth Dco of the open sipes 71 disposed in the center blocks 41 to the groove depth D1 of the circumferential narrow groove 21 is Dco/D1>0.8, or when the ratio of the sipe depth Dmo of the open sipes 71 disposed in the middle blocks 42 is Dmo/D1>0.8, the sipe depth Dco and Dmo may become too deep. In this case, rigidity of the center blocks 41 and the middle blocks 42 may decrease, making the blocks excessively liable to deform, and the rolling resistance liable to deteriorate.

In contrast, when the ratio of the sipe depth Dco of the open sipes 71 disposed in the center blocks 41 to the groove depth D1 of the circumferential narrow groove 21 is in a range 0.5≤Dco/D1≤0.8, and the ratio of the sipe depth Dmo of the open sipes 71 disposed in the middle blocks 42 is in a range 0.5≤Dmo/D1≤0.8, it is possible to suppress the rigidity of the center blocks 41 and the middle blocks 42 from becoming too low and excessively liable to deform, while improving on-snow performance by appropriately deforming the center blocks 41 and the middle blocks 42 to obtain the edge effect of the open sipes 71. As a result of the foregoing, it is possible to reduce the rolling resistance while suppressing decrease of on-snow performance more reliably.

The center lug groove 51 and the middle lug groove 52 are each inclined in a range of 10° or more and 25° or less in the tire circumferential direction with respect to the tire width direction, thereby improving on-snow performance. In other words, when the inclination angle θc of the center lug groove 51 and the inclination angle θm of the middle lug groove 52 are less than 10°, the inclination angles θc and θm of the lug grooves 50 are too small, and therefore it may be difficult to ensure the edge components of the center lug groove 51 and the middle lug groove 52 in the tire width direction. When the inclination angle θc of the center lug groove 51 and the inclination angle θm of the middle lug groove 52 are larger than 25°, the inclination angles θc and θm of the lug grooves 50 are too large, and therefore the edge component with respect to the tire circumferential direction may become small.

In contrast, when the inclination angle θc of the center lug groove 51 and the inclination angle θm of the middle lug groove 52 are in a range of 10° or more and 25° or less, the edge component in the edge width direction and the edge component in the tire circumferential direction with respect to the tire circumferential direction of both of the lug grooves 50, namely, the center lug groove 51 and the middle lug groove 52, can be ensured in a well-balanced manner. As a result, it is possible to improve on-snow performance.

Since the center lug groove 51 and the middle lug groove 52 are inclined toward different directions in the tire circumferential direction with respect to the tire width direction, edge components can act on the center lug groove 51 and the middle lug groove 52 in different directions, whereby the edge effect can be exhibited in a larger number of directions. As a result, it is possible to improve on-snow performance.

The ratio of the sipe depth Dcc of the closed sipes 72 disposed in the center blocks 41 to the groove depth D1 of the circumferential narrow groove 21 is in a range 0.5≤Dcc/D1≤0.9, and the ratio of the sipe depth Dmc of the closed sipes 72 disposed in the middle blocks 42 to the groove depth D1 of the circumferential narrow groove 21 is in a range 0.5≤Dmc/D1≤0.9, it is possible to reduce the rolling resistance while suppressing decrease of on-snow performance more reliably. In other words, when the ratio of the sipe depth Dcc of the closed sipes 72 disposed in the center blocks 41 to the groove depth D1 of the circumferential narrow groove 21 is Dcc/D1<0.5, or the ratio of the sipe depth Dmc of the closed sipes 72 disposed in the middle blocks 42 is Dmc/D1<0.5, the sipe depth Dcc and Dmc may become too shallow. In this case, even when a load is applied to the center blocks 41 or the middle blocks 42, deformation of the blocks may become too small, and the edge of the closed sipe 72 may become difficult to rise, making it difficult to obtain the edge effect of the closed sipe 72 and improve on-snow performance. When the ratio of the sipe depth Dcc of the closed sipes 72 disposed in the center blocks 41 to the groove depth D1 of the circumferential narrow groove 21 is Dcc/D1>0.9, or the ratio of the sipe depth Dmc of the closed sipes 72 disposed in the middle blocks 42 is Dmc/D1>0.9, the sipe depth Dcc and Dmc may become too deep. In this case, rigidity of the center blocks 41 and the middle blocks 42 may decrease, making the blocks excessively liable to deform, and the rolling resistance liable to deteriorate.

In contrast, when the ratio of the sipe depth Dcc of the closed sipes 72 disposed in the center blocks 41 to the groove depth D1 of the circumferential narrow groove 21 is in a range 0.5≤Dcc/D1≤0.9, and the ratio of the sipe depth Dmc of the closed sipes 72 disposed in the middle blocks 42 is in a range 0.5≤Dmc/D1≤0.9, it is possible to suppress the rigidity of the center blocks 41 and the middle blocks 42 from becoming too low and making the blocks excessively liable to deform, while improving on-snow performance by appropriately deforming the center blocks 41 and the middle blocks 42 to obtain the edge effect of the closed sipe 72. As a result of the foregoing, it is possible to reduce the rolling resistance while suppressing decrease of on-snow performance more reliably.

With regard to the lug groove 51 and the middle lug groove 52 opening to the same circumferential narrow groove 21, the opening portions 51a of the center lug groove 51 and the opening portions 52b of the middle lug groove 52 with respect to the circumferential narrow groove 21 are alternately disposed in the tire circumferential direction and therefore snow column shear force generated at portions where the circumferential narrow groove 21 and the center lug groove 51 intersect and snow column shear force generated at portions where the circumferential narrow groove 21 and the middle lug groove 52 intersect can be alternately generated in the tire circumferential direction during travel on snow-covered road surfaces. Accordingly, it is possible to continuously generate snow shear force during travel on snow-covered road surfaces, whereby the snow shear force can be improved, and the traction performance during travel on snow-covered road surfaces can be enhanced. As a result, it is possible to improve on-snow performance.

Since the inclination angle θ1 of the groove wall 21b of the circumferential narrow groove 21 is in a range 0°≤θ1≤3°, it is possible to suppress decrease of on-snow performance more reliably. In other words, when the inclination angle θ1 of the groove wall 21b of the circumferential narrow groove 21 satisfies θ1>3°, the inclination angle θ1 of the groove wall 21b is too large, whereby the groove width of the side of the groove bottom 21c may become too small, and the entire volume of the circumferential narrow groove 21 may become too small. In this case, the amount of snow entering the circumferential narrow groove 21 during travel on snow-covered road surfaces may decrease, making it difficult to ensure the snow column shear force, and it may become difficult to improve on-snow performance.

In contrast, when the inclination angle θ1 of the groove wall 21b of the circumferential narrow groove 21 is in a range 0°≤θ1≤3°, it may become easier for snow to enter the circumferential narrow groove 21 during travel on snow-covered road surfaces, and it may become easier to strengthen the snow column shear force. As a result, it is possible to suppress decrease of on-snow performance more reliably.

Since the rubber hardness of the cap tread 4 included in the tread portion 2 is in a range of 60 or more and 70 or less, it is possible to reduce the rolling resistance while suppressing decrease of the on-ice performance. In other words, when the rubber hardness of the cap tread 4 is less than 60, the rubber hardness is too soft, and therefore deformation of the land portion row 30 becomes too large during travel of the vehicle, and rolling resistance may easily deteriorate. When the rubber hardness of the cap tread 4 is larger than 70, the rubber hardness is too stiff and therefore the degree of adhesion of the tread ground contact surface 3 to the road surface during travel on ice-covered road surfaces may decrease, and the grip performance may easily decrease.

In contrast, when the rubber hardness of the cap tread 4 is in a range of 60 or more and 70 or less, it is possible to ensure the degree of adhesion of the tread ground contact surface 3 to the road surface during travel on ice-covered road surfaces, while suppressing deformation of the land portion row 30 from becoming too large during travel of the vehicle. As a result, it is possible to reduce the rolling resistance while suppressing decrease of the on-ice performance.

Since the modulus of the cap tread 4 included in the tread portion 2 at 300% elongation is in a range of 8 MPa or more and 16 MPa or less, it is possible to reduce the rolling resistance while suppressing decrease of the on-ice performance. In other words, when the modulus of the cap tread 4 at 300% elongation is less than 8 MPa, the modulus of the cap tread 4 is too low, and therefore deformation of the land portion row 30 during travel of the vehicle may become too large, making the rolling resistance more liable to deteriorate. When the modulus of the cap tread 4 at 300% elongation is larger than 16 MPa, the modulus of the cap tread 4 is too high, and therefore the degree of adhesion of the tread ground contact surface 3 to the road surface during travel on ice-covered road surfaces may decrease, making the grip performance more liable to decrease.

In contrast, when the modulus of the cap tread 4 at 300% elongation is in a range of 8 MPa or more and 16 MPa or less, it is possible to ensure the degree of adhesion of the tread ground contact surface 3 to the road surface during travel on an ice-covered road surface, while suppressing excessive deformation of the land portion row 30 during travel of the vehicle. As a result, it is possible to reduce the rolling resistance while suppressing decrease of the on-ice performance.

### MODIFIED EXAMPLES

In the embodiments described above, the center lug groove 51 and the middle lug groove 52 are formed into a crank shape, and the shoulder narrow groove 60 is disposed in the shoulder land portion row 33, but the lug groove 50 and the land portion row 30 may be formed according to embodiments other than these.

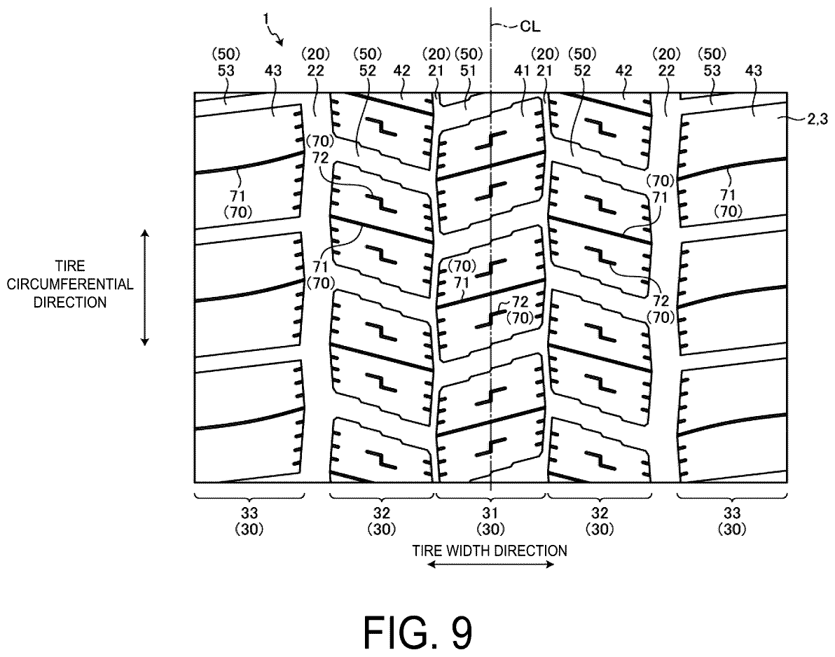

FIG. 9 is an explanatory diagram of a variation example of the pneumatic tire 1 according to an embodiment in which the lug groove 50 is formed into a shape other than a crank, without having the shoulder narrow grooves 60. The center lug groove 51 and the middle lug groove 52 may be formed into a step shape by repeatedly bending while extending in the tire width direction, as illustrated in FIG. 9, for example. The shoulder narrow grooves 60 (see FIG. 2) may not be disposed in the shoulder land portion row 33, and the shoulder lug groove 53 may not have the inner shoulder lug groove 53a (see FIG. 2) and the outer shoulder lug groove 53b (see FIG. 2).

Additionally, in the embodiments described above, although a total of four grooves, namely, two circumferential narrow grooves 21 and two shoulder circumferential grooves 22 are disposed with regard to the circumferential grooves 20 extending in the tire circumferential direction, any number other than four of the circumferential grooves 20 may be disposed in the tread portion 2. There may be disposed five circumferential grooves 20, for example, by disposing the circumferential narrow grooves 21 on the tire equatorial plane CL. It suffices to have at least four circumferential grooves 20 to be disposed in the tread portion 2.

Additionally, in the embodiment described above, although the tire according to an embodiment of the present technology has been explained using the pneumatic tire 1 as an example, the tire according to the embodiment of the present technology may be any tire other than the pneumatic tire 1. The tire according to an embodiment of the present technology may be a so-called airless tire, for example, that can be used without filling gas.

### Examples

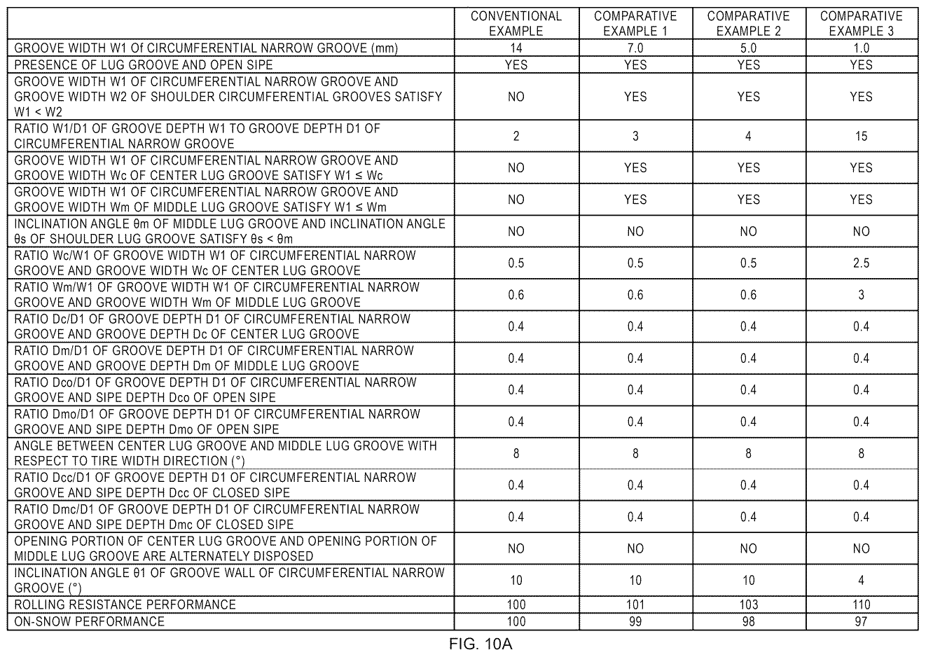

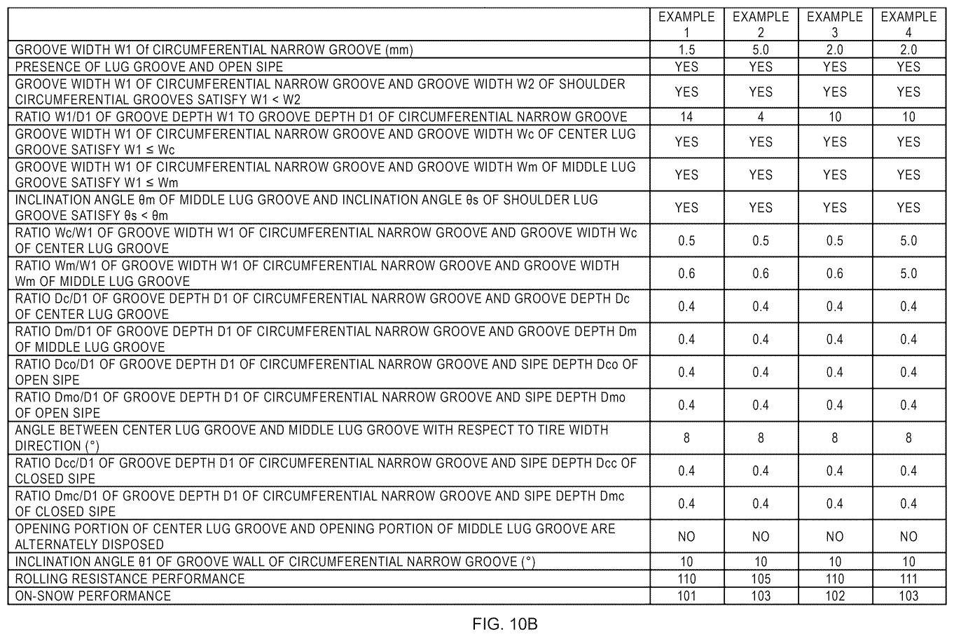

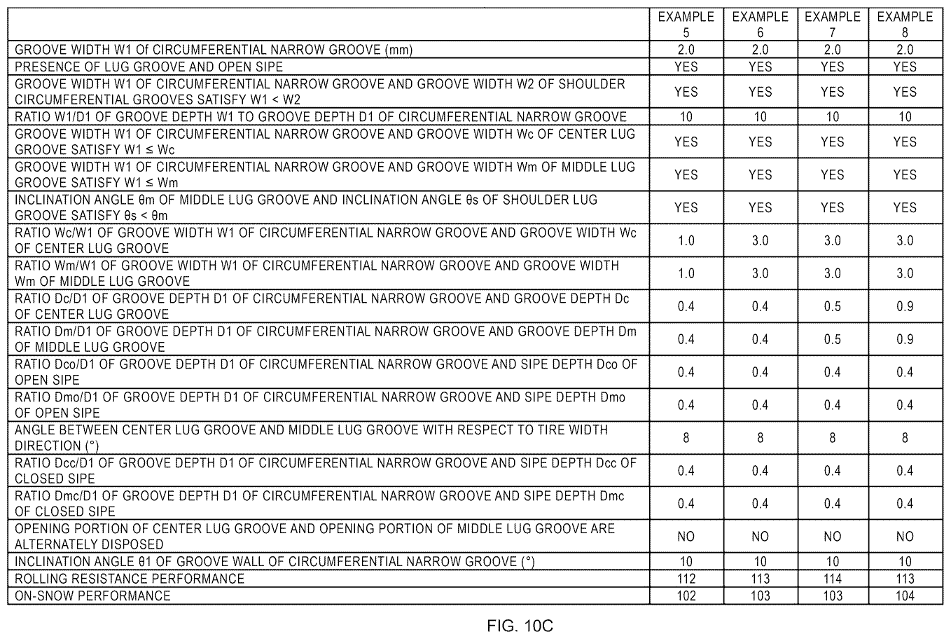

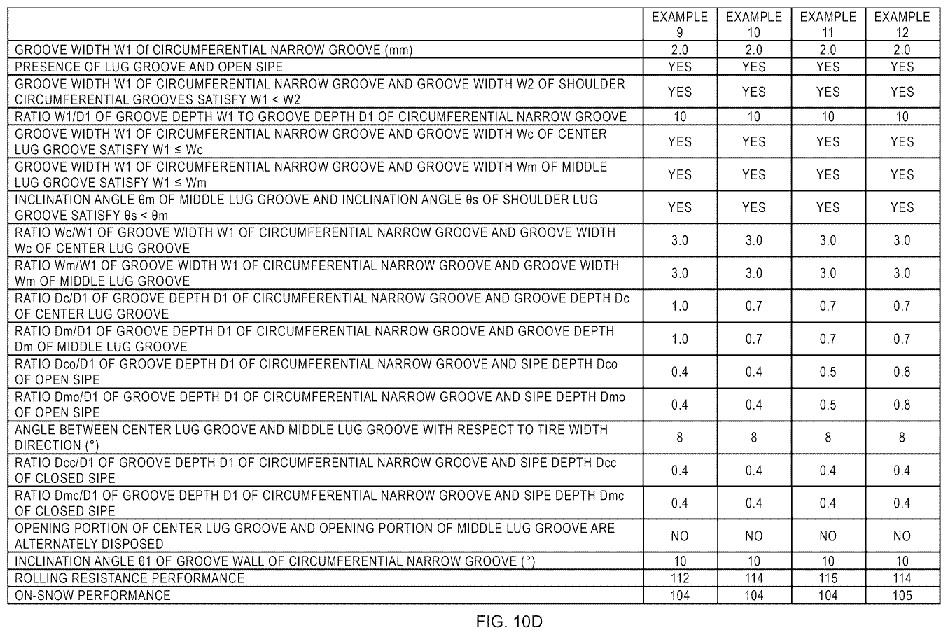

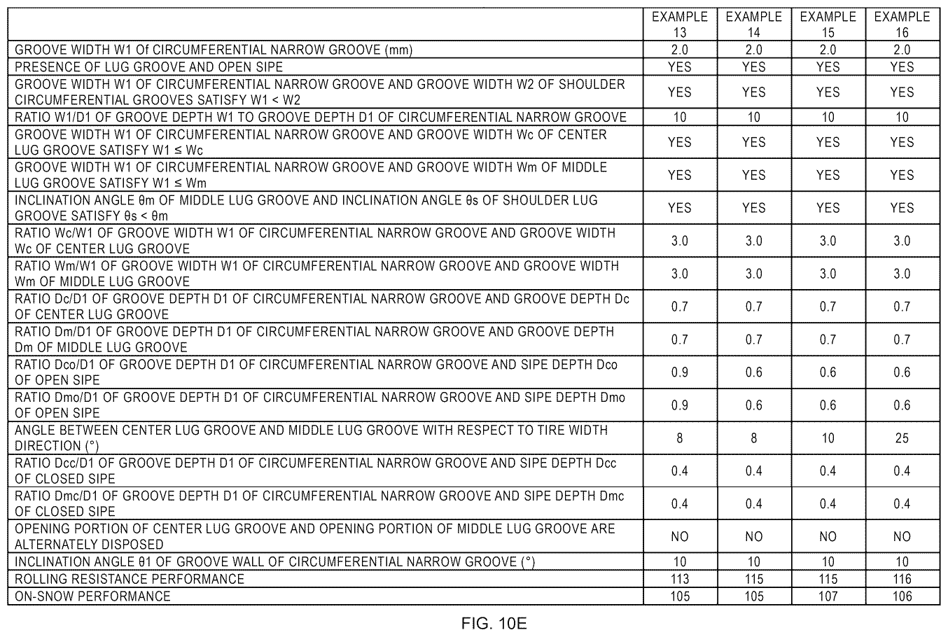

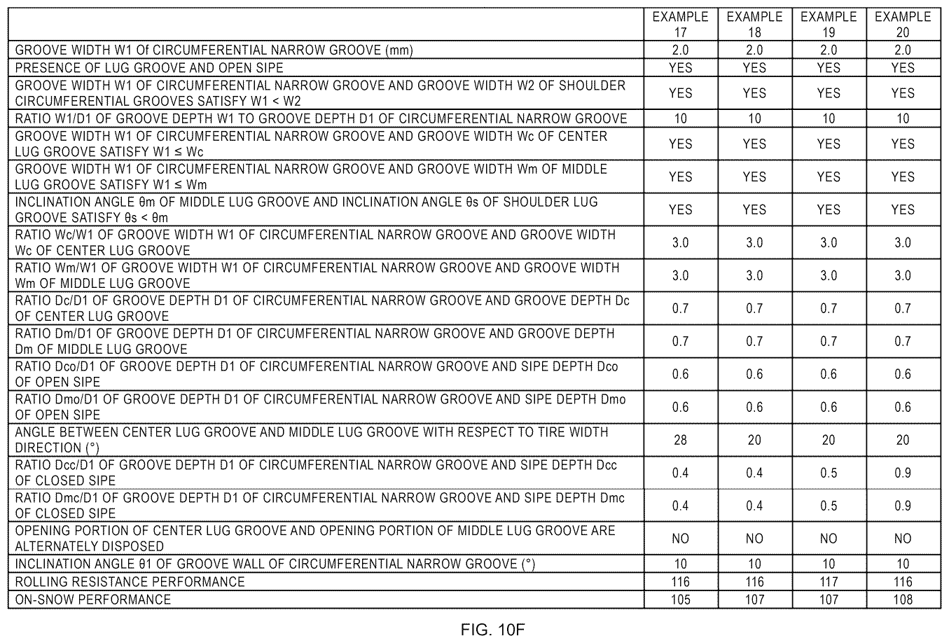

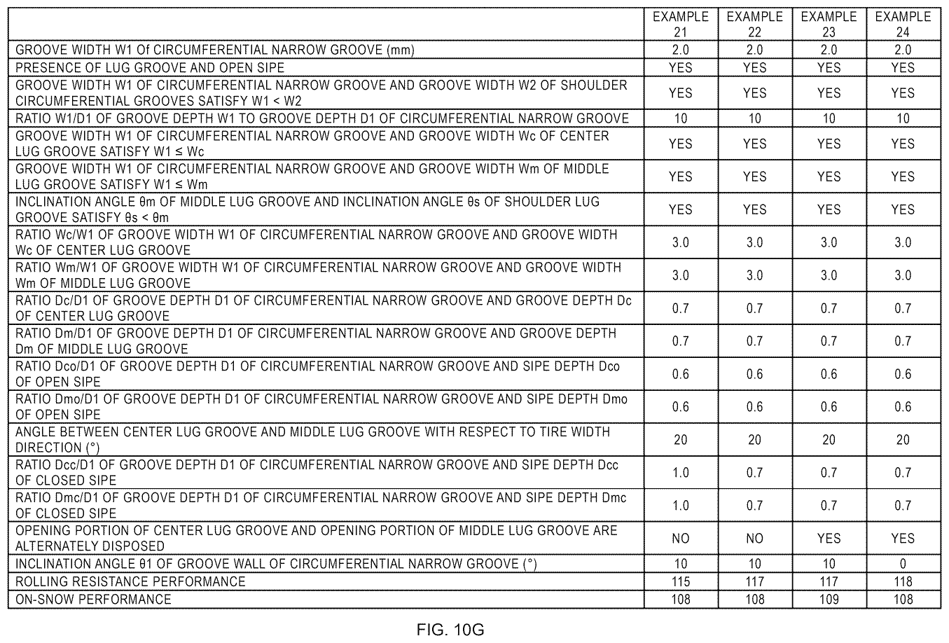

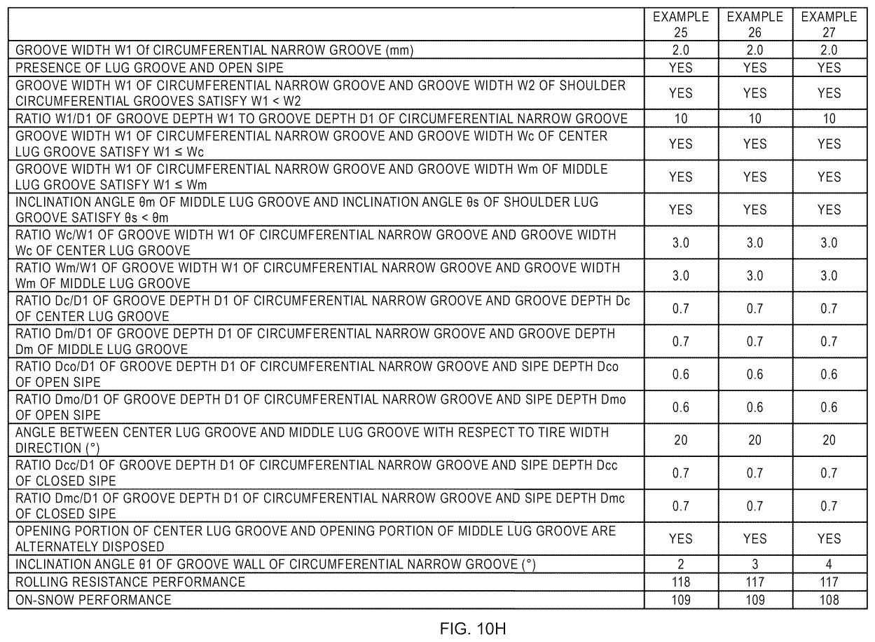

FIGS. 10A to 10H are tables indicating the results of performance evaluation tests of pneumatic tires. There will be described in the following, with regard to the pneumatic tire 1 described above, performance evaluation tests performed on a pneumatic tire according to a Conventional Example, the pneumatic tire 1 according to an embodiment of the present technology, and a pneumatic tire according to a Comparative Example to be compared with the pneumatic tires 1 according to the present technology. The performance evaluation tests were performed with regard to rolling resistance performance and on-snow performance.

The performance evaluation tests were performed under the conditions that the pneumatic tire 1 with a nominal tire size of 275/70R22.5 was mounted on a rim of a specified rim size and air pressure was adjusted to a specified air pressure.

The evaluation method of each test item was such that the evaluation test of rolling resistance performance calculated a rolling resistance coefficient were using a drum testing machine with a drum diameter of 1707 mm under a speed condition of 80 km/h in accordance with ISO28580. The performance was evaluated by expressing the results as indices with the inverse of the rolling resistance coefficient of Comparative Example taken as 100. The evaluation shows that the larger the index values, the lower the rolling resistance and the more superior the rolling resistance performance.

The on-snow acceleration performance test, which was performed in accordance with UN R117-04 (UN Regulation No. 117 Revision 4), calculated the acceleration was by measuring a distance required for accelerating a test vehicle having the test tires mounted thereon from a specified initial speed to a terminal speed on a snow-covered road surface. The on-snow acceleration performance was evaluated by expressing the calculated acceleration by indices with the Comparative Example taken as 100 as described below, indicating that the larger the numerical value, the higher the acceleration performance on snow-covered road surfaces and the more superior the on-snow acceleration performance is.

Performance evaluation tests were performed on a total of 31 types of pneumatic tires, namely, a pneumatic tire according to Conventional Example as an example of a conventional pneumatic tire, Examples 1 to 27 corresponding to the pneumatic tires 1 according to an embodiment of the present technology, and Comparative Examples 1 to 3 of pneumatic tires to be compared with the pneumatic tire 1 according to an embodiment of the present technology. Among the tires tested, the pneumatic tire of the conventional example does not have a circumferential narrow groove whose groove width is in a range of 1.5 mm or more and 5.0 mm or less, and the inclination angle θm of the middle lug groove and the inclination angle θs of the shoulder lug groove do not satisfy the relationship θs <0m. The inclination angle θm of the middle lug groove and the inclination angle θs of any of the shoulder lug groove of the pneumatic tires of the Comparative Examples 1 to 3 do not satisfy the relationship θs<θm.

In contrast, all the Examples 1 to 27 representing an example of the pneumatic tire 1 according to an embodiment of the present technology have the groove width W1 of the circumferential narrow groove 21 in a range 1.5 mm≤W1≤5.0 mm, the relationship between the groove width W1 and the groove depth D1 of the circumferential narrow groove 21 satisfying 4≤D1/W1≤14, the groove width W1 of the circumferential narrow groove 21 and the groove width Wc of the center lug groove 51 satisfying the relationship W1≤Wc, the groove width W1s of the circumferential narrow groove 21 and the groove width Wm of the middle lug groove 52 satisfying the relationship W1≤Wm, and the inclination angle θm of the middle lug groove 52 and the inclination angles θs of the shoulder lug groove 53 satisfying the relationship θs<θm. Furthermore, for the pneumatic tires 1 according to Examples 1 to 27, the ratio Wc/W1 of the groove width Wc of the center lug groove 51 to the groove width W1 of the circumferential narrow groove 21, the ratio Wm/W1 of the groove width Wm of the middle lug groove 52 to the groove width W1 of the circumferential narrow groove 21, the ratio Dc/D1 of the groove depth Dc of the center lug groove 51 to the groove depth D1 of the circumferential narrow groove 21, the ratio Dm/D1 of the groove depth Dm of the middle lug groove 52 to the groove depth D1 of the circumferential narrow groove 21, the ratio Dco/D1 of the sipe depth Dco of the open sipes 71 disposed in the center blocks 41 to the groove depth D1 of the circumferential narrow groove 21, the ratio Dmo/D1 of the sipe depth Dmoc of the open sipes 71 disposed in the middle blocks 42 to the groove depth D1 of the circumferential narrow groove 21, the angle of each of the center lug groove 51 and the middle lug groove 52 with respect to the lug groove 50 in the tire width direction, the ratio Dcmc/D1 of the sipe depth Dcmc of the closed sipes 72 disposed in the center blocks 41 to the groove depth D1 of the circumferential narrow groove 21, the ratio Dmc/D1 of the sipe depth Dmc of the closed sipes 72 disposed in the middle blocks 42 to the groove depth D1 of the circumferential narrow groove 21, whether or not the opening portions 51a of the center lug groove 51 and the opening portions 52b of the middle lug groove 52 are alternately disposed in the tire circumferential direction with respect to the circumferential narrow groove 21, and the inclination angle θ1 between the groove wall 21b of the circumferential narrow groove 21 are different from each other.

As a result of performing performance evaluation tests using the pneumatic tires 1, it has been found that the pneumatic tires 1 according to the Examples 1 to 27 can improve the rolling resistance performance and the on-snow performance, respectively, in comparison with the Conventional Examples, as illustrated in FIGS. 10A to 10H. In other words, the pneumatic tires 1 according to the Examples 1 to 27 can reduce the rolling resistance performance while suppressing decrease of on-snow performance.

The present disclosure includes the following technologies.

### Technology 1

A tire, including:
at least four circumferential grooves disposed in a tread portion and extending in a tire circumferential direction; and
a plurality of land portion rows defined by the circumferential grooves, the land portion rows including
a center land portion row that is a land portion row of the land portion rows disposed at a position closest to a tire equatorial plane;
a middle land portion row that is the land portion row adjacent to the center land portion row with a circumferential groove of the circumferential grooves interposed; and
a shoulder land portion row that is the land portion row located outermost in the tire width direction among the plurality of land portion rows and adjacent to the middle land portion row with the circumferential groove interposed,
the circumferential groove separating the center land portion row from the middle land portion row being a circumferential narrow groove having a groove width W1 in a range 1.5 mm≤W1≤5.0 mm,
in each of the center land portion row and the middle land portion row each a lug groove both ends of which open to the circumferential groove being disposed, thereby the center land portion row having a center block, both sides of which in the tire circumferential direction are defined by the lug groove, and the middle land portion row having a middle block, both sides of which in the tire circumferential direction are defined by the lug groove,
in each of the center block and the middle block an open sipe both ends of which open to the circumferential grooves being disposed,
a groove width W2 of a shoulder circumferential groove that is the circumferential groove separating the middle land portion row from the shoulder land portion row and the groove width W1 of the circumferential narrow groove satisfying a relationship W1<W2,
a groove depth D1 of the circumferential narrow groove and the groove width W1 satisfying a relationship 4≤D1/W1≤14,
a groove width Wc of a center lug groove that is the lug groove defining the center block and the groove width W1 of the circumferential narrow groove satisfying a relationship W1≤Wc,
a groove width Wm of a middle lug groove that is the lug groove defining the middle block and the groove width W1 of the circumferential narrow groove satisfying a relationship W1≤Wm,
a shoulder lug groove that is a lug groove opening to the shoulder circumferential groove being disposed in the shoulder land portion row, and an inclination angle θs in the tire circumferential direction with respect to the tire width direction of the shoulder lug groove and an inclination angle θm in the tire circumferential direction with respect to the tire width direction of the middle lug groove satisfying a relationship θs<θm.

### Technology 2

The tire according to the technology 1, wherein
the center lug groove has a ratio of the groove width Wc to the groove width W1 of the circumferential narrow groove in a range 1≤Wc/W1≤5, and
the middle lug groove has a ratio of the groove width Wm to the groove width W1 of the circumferential narrow groove in a range 1≤Wm/W1≤5.

### Technology 3

The tire according to the technology 1 or 2, wherein
the center lug groove has a ratio of the groove depth Dc to the groove depth D1 of the circumferential narrow groove in a range 0.5≤Dc/D1≤0.9, and
the middle lug groove has a ratio of the groove depth Dm to the groove depth D1 of the circumferential narrow groove in a range 0.5≤(Dm/D1)≤0.9.

### Technology 4

The tire according to any one of the technologies 1 to 3, wherein
the open sipe disposed in the center block has a ratio of the sipe depth Dco to the groove depth D1 of the circumferential narrow groove in a range 0.5≤Dco/D1 ≤0.8, and
the open sipe disposed in the middle block has a ratio of the sipe depth Dmo to the groove depth D1 of the circumferential narrow groove in a range 0.5≤Dmo/D1≤0.8.

### Technology 5

The tire according to any one of the technologies 1 to 4, wherein the center lug groove and the middle lug groove are inclined in a range of 10° or more and 25° or less in the tire circumferential direction with respect to the tire width direction, and have different inclination directions in the tire circumferential direction with respect to the tire width direction from each other.

### Technology 6

The tire according to any one of the technologies 1 to 5, wherein
in the center block, a closed sipe both ends of which terminate within the center block,
in the middle block, a closed sipe both ends of which terminate within the middle block,
the closed sipe disposed in the center block has a ratio of the sipe depth Dcc to the groove depth D1 of the circumferential narrow groove in a range 0.5≤Dcc/D1≤0.9, and
the closed sipe disposed in the middle block has a ratio of the sipe depth Dmc to the groove depth D1 of the circumferential narrow groove in a range 0.5≤Dmc/D1≤0.9.

### Technology 7

The tire according to any one of the technologies 1 to 6, wherein for the center lug groove and the middle lug groove opening to the same circumferential groove, an opening of the center lug groove to the circumferential groove and an opening of the middle lug groove to the circumferential groove are alternately disposed in the tire circumferential direction.

### Technology 8

The tire according to any one of the technologies 1 to 7, wherein the circumferential narrow groove has an inclination angle θ1 of the groove wall in a range 0°≤θ1≤3° in a case where an inclination angle of the groove wall is positive when the groove wall is inclined in a direction in which a groove width becomes narrower from a side of the opening portion to a tread ground contact surface toward a side of the groove bottom.

### Technology 9

The tire according to any one of the technologies 1 to 8, wherein
the tread portion includes a cap tread constituting a tread ground contact surface, and
rubber hardness of the cap tread is in a range of 60 or more and 70 or less.

### Technology 10

The tire according to any one of the technologies 1 to 9, wherein
the tread portion includes a cap tread constituting a tread ground contact surface, and
a modulus of the cap tread at 300% elongation is in a range of 8 MPa or more and 16 MPa or less.

1. A tire, comprising:
at least four circumferential grooves disposed in a tread portion and extending in a tire circumferential direction; and
a plurality of land portion rows defined by the circumferential grooves; the land portion rows including
a center land portion row that is a land portion row of the land portion rows disposed at a position closest to a tire equatorial plane,
a middle land portion row that is the land portion row adjacent to the center land portion row with a circumferential groove of the circumferential grooves interposed, and
a shoulder land portion row that is the land portion row located outermost in the tire width direction among the plurality of land portion rows and adjacent to the middle land portion row with the circumferential groove interposed,
the circumferential groove separating the center land portion row from the middle land portion row being a circumferential narrow groove having a groove width W1 in a range 1.5 mm≤W1≤5.0 mm, in each of the center land portion row and the middle land portion row a lug groove both ends of which open to the circumferential groove being disposed, thereby the center land portion row having a center block, both sides of which in the tire circumferential direction are defined by the lug groove, and the middle land portion row having a middle block, both sides of which in the tire circumferential direction are defined by the lug groove, in each of the center block and the middle block, an open sipe both ends of which open to the circumferential grooves being disposed,
a groove width W2 of a shoulder circumferential groove that is the circumferential groove separating the middle land portion row from the shoulder land portion row and the groove width W1 of the circumferential narrow groove satisfying a relationship W1<W2,
a groove depth D1 and the groove width W1 of the circumferential narrow groove satisfying a relationship 4≤D1/W1≤14,
a groove width Wc of a center lug groove that is the lug groove defining the center block and the groove width W1 of the circumferential narrow groove satisfying a relationship W1≤Wc,
a groove width Wm of a middle lug groove that is the lug groove defining the middle block and the groove width W1 of the circumferential narrow groove satisfying a relationship W1≤Wm,
a shoulder lug groove that is a lug groove opening to the shoulder circumferential groove being disposed in the shoulder land portion row, and an inclination angle θs in the tire circumferential direction with respect to the tire width direction of the shoulder lug groove and an inclination angle Om in the tire circumferential direction with respect to the tire width direction of the middle lug groove satisfying a relationship θs<θm.

2. The tire according to claim 1, wherein the center lug groove has a ratio of the groove width Wc to the groove width W1 of the circumferential narrow groove in a range 1≤Wc/W1≤5, and the middle lug groove has a ratio of the groove width Wm to the groove width W1 of the circumferential narrow groove in a range 1≤Wm/W1≤5.

3. The tire according to claim 1, wherein the center lug groove has a ratio of the groove depth Dc to the groove depth D1 of the circumferential narrow groove in a range 0.5≤Dc/D1≤0.9, and the middle lug groove has a ratio of the groove depth Dm to the groove depth D1 of the circumferential narrow groove in a range 0.5≤(Dm/D1)≤0.9.

4. The tire according to claim 1, wherein the open sipe disposed in the center block has a ratio of the sipe depth Dco to the groove depth D1 of the circumferential narrow groove in a range 0.5≤Dco/D1≤0.8, and the open sipe disposed in the middle block has a ratio of the sipe depth Dmo to the groove depth D1 of the circumferential narrow groove in a range 0.5≤Dmo/D1≤0.8.

5. The tire according to claim 1, wherein the center lug groove and the middle lug groove are inclined in a range of 10° or more and 25° or less in the tire circumferential direction with respect to the tire width direction and have different inclination directions in the tire circumferential direction with respect to the tire width direction from each other.

6. The tire according to claim 1, wherein in the center block, a closed sipe both ends of which terminate within the center block is disposed, in the middle block, a closed sipe both ends of which terminate within the middle block,
the closed sipe disposed in the center block has a ratio of the sipe depth Dcc to the groove depth D1 of the circumferential narrow groove in a range 0.5≤Dcc/D1≤0.9, and the closed sipe disposed in the middle block has a ratio of the sipe depth Dmc to the groove depth D1 of the circumferential narrow groove in a range 0.5≤Dmc/D1≤0.9.

7. The tire according to claim 1, wherein for the center lug groove and the middle lug groove opening to the same circumferential groove, an opening of the center lug groove to the circumferential groove and an opening of the middle lug groove to the circumferential groove are alternately disposed in the tire circumferential direction.

8. The tire according to claim 1, wherein the circumferential narrow groove has an inclination angle θ1 of a groove wall in a range 0°≤θ1≤3° in a case where an inclination angle of the groove wall is positive when the groove wall is inclined in a direction in which a groove width becomes narrower from a side of the opening portion to a tread ground contact surface toward a side of the groove bottom.

9. The tire according to claim 1, wherein the tread portion includes a cap tread constituting a tread ground contact surface, and rubber hardness of the cap tread is in a range of 60 or more and 70 or less.

10. The tire according to claim 1, wherein the tread portion includes a cap tread constituting a tread ground contact surface, and a modulus of the cap tread at 300% elongation is in a range of 8 MPa or more and 16 MPa or less.
